(19) United States
(12) Patent Application Publication
(10) Pub. No.: US 2025/0348011 A1
(43) Pub. Date: Nov. 13, 2025

(54) IMAGE FORMING APPARATUS

(71) Applicant: CANON KABUSHIKI KAISHA, Tokyo (JP)

(72) Inventors: SHUMA HIASA, Kanagawa (JP); TOMOYA TATEISHI, Kanagawa (JP); JUMPEI NITTA, Kanagawa (JP)

(21) Appl. No.: 19/196,063

(22) Filed: May 1, 2025

(30) Foreign Application Priority Data
May 7, 2024 (JP) 2024-075518
Mar. 14, 2025 (JP) 2025-041798

(51) Int. Cl. G03G 15/01; G03G 15/00; G03G 21/16

(52) U.S. Cl. CPC G03G 15/0173; G03G 15/6529; G03G 21/1619; G03G 21/1647

(57) ABSTRACT

An image forming apparatus includes a rotary including a storage frame to which a toner cartridge is attachable, a conveyance portion, a first motor, a first drive transmission portion, and a second drive transmission portion. The first drive transmission portion is configured to transition to (i) a first state of transmitting a driving force of the first motor to the rotary in a state where the first motor rotates in a first direction, (ii) a second state of not transmitting the driving force to the rotary in a state where the first motor rotates in a second direction, and (iii) a third state of transmitting the driving force to the rotary in a state where the first motor rotates in the second direction. The second drive transmission portion transmits the driving force to the conveyance portion in a state where the first motor rotates in the second direction.

### BACKGROUND OF THE INVENTION

### Field of the Invention

The present invention relates to an image forming apparatus that forms images on recording materials.

### Description of the Related Art

In an image forming apparatus of an electrophotographic system, a rotary developing system that forms a color image by rotating a rotary equipped with multiple developing members is known. Japanese Patent Application Laid-Open Publication Nos. 2007-183305 and 2008-096852 each disclose an image forming apparatus including a rotary equipped with a plurality of developing rollers, and a plurality of toner cartridges, i.e., toner storage containers, that may each be attached to and detached from the rotary.

In recent years, it has been desired to configure the rotary to be capable of rotating in both forward and reverse directions while reducing costs.

### SUMMARY OF THE INVENTION

According to a first aspect of the present invention, an image forming apparatus to which a toner cartridge is detachably attached and that forms an image on a recording material includes a rotary configured to rotate, the rotary including a developing roller, and a storage frame to which the toner cartridge is attachable, the storage frame including a storage portion configured to accommodate toner being supplied to the developing roller, a conveyance portion configured to convey the recording material, a first motor configured to drive the rotary and the conveyance portion, the first motor being configured to rotate in a first direction and in a second direction opposite to the first direction, a first drive transmission portion configured to transmit a drive from first motor to the rotary, and a second drive transmission portion configured to transmit a drive from the first motor to the conveyance portion. The first drive transmission portion is configured to transition to (i) a first state of transmitting the drive from the first motor to the rotary such that the rotary rotates in a third direction in a state where the first motor rotates in the first direction, (ii) a second state of not transmitting the drive from the first motor to the rotary in a state where the first motor rotates in the second direction, and (iii) a third state of transmitting the drive from the first motor to the rotary such that the rotary rotates in a fourth direction opposite to the third direction in a state where the first motor rotates in the second direction. The second drive transmission portion is configured to transmit the drive from the first motor to the conveyance portion in a state where the first motor rotates in the second direction.

According to a second aspect of the present invention, an image forming apparatus that forms an image on a recording material includes a first output portion, a second output portion that differs from the first output portion, a first motor configured to drive the first output portion and the second output portion, the first motor being configured to rotate in a first direction and in a second direction opposite to the first direction, a first drive transmission portion including a switching portion and a restriction member, the first drive transmission portion being configured to transmit a drive from the first motor to the first output portion, a second drive transmission portion configured to transmit a drive from the first motor to the second output portion, and a second motor configured to drive the restriction member. The switching portion is configured to transition to a transmission state in which the switching portion transmits the drive from the first motor toward the first output portion and to a non-transmission state in which the switching portion does not transmit the drive from the first motor toward the first output portion. The restriction member is configured to move by the drive from the second motor to an allowing position in which the restriction member allows the switching portion to transition to the non-transmission state and to a restricting position in which the restriction member restricts the switching portion from transitioning to the non-transmission state. The first drive transmission portion is configured to transition to a first state, a second state, and a third state, the first drive transmission portion, in the first state, transmitting the drive from the first motor to the first output portion such that the first output portion rotates in a third direction in a case where the first motor rotates in the first direction, the switching portion, in a state where the first drive transmission portion is in the second state, transitioning to the non-transmission state in a case where the restriction member is positioned at the allowing position and where the first motor rotates in the second direction, the first drive transmission portion, in the third state, transmitting the drive from the first motor to the first output portion such that the first output portion rotates in a fourth direction opposite to the third direction in a case where the restriction member is positioned at the restricting position and where the first motor rotates in the second direction. The second drive transmission portion transmits the drive from the first motor to the second output portion in a state where the first motor rotates in the second direction.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to a first embodiment.

FIG. 2 is a configuration diagram of the image forming apparatus according to the first embodiment.

FIG. 3 is a schematic diagram of a developing unit, a toner cartridge and a tray according to the first embodiment.

FIGS. 4A and 4B are each a cross-sectional view of the image forming apparatus according to the first embodiment.

FIG. 5 is a perspective view of a rotary body according to the first embodiment.

FIGS. 6A to 6C are each a perspective view of the image forming apparatus according to the first embodiment.

FIGS. 7A and 7B are each a cross-sectional view of the image forming apparatus according to the first embodiment.

FIG. 8 is an explanatory view of the rotary body according to the first embodiment.

FIG. 9 is an explanatory view of the rotary body according to the first embodiment.

FIG. 10 is an explanatory view of the rotary body according to the first embodiment.

FIGS. 11A and 11B are each an explanatory view of a configuration related to the movement of the tray according to the first embodiment.

FIGS. 12A and 12B are each an explanatory view of a configuration related to the movement of the tray according to the first embodiment.

FIGS. 13A and 13B are each a perspective view of a configuration of a drive mechanism of the tray according to the first embodiment.

FIGS. 14A and 14B are each a perspective view of a stepped gear according to the first embodiment.

FIG. 15 is a perspective view of a locking member according to the first embodiment.

FIGS. 16A and 16B are each a front view illustrating an operation of a lock mechanism according to the first embodiment.

FIGS. 17A and 17B are each a perspective view illustrating an operation of the lock mechanism according to the first embodiment.

FIGS. 18A and 18B are each a view illustrating a drive transmission configuration from a motor to a rotary body and a conveyance unit according to the first embodiment.

FIGS. 19A to 19C are each a perspective view of a rotary driving ratchet gear according to the first embodiment.

FIGS. 20A to 20C are each a view illustrating an engagement operation of the rotary driving ratchet gear according to the first embodiment.

FIGS. 21A and 21B are each a view illustrating a separating operation of the rotary driving ratchet gear according to the first embodiment.

FIGS. 22A to 22C are each a perspective view of a conveyance driving ratchet gear according to the first embodiment.

FIGS. 23A to 23C are each a view illustrating an engagement operation of the conveyance driving ratchet gear according to the first embodiment.

FIGS. 24A and 24B are each a view illustrating a separating operation of the conveyance driving ratchet gear according to the first embodiment.

FIGS. 25A and 25B are each a view illustrating a moving distance of the rotary body according to the first embodiment.

FIGS. 26A and 26B are each a cross-sectional view illustrating a restricting lever according to the first embodiment.

FIGS. 27A and 27B are each a cross-sectional view of an operation of the restricting lever according to the first embodiment.

FIG. 28 is a perspective view illustrating a peripheral configuration of the restricting lever according to the first embodiment.

FIGS. 29A and 29B are each a front view illustrating a state where the restricting lever is moved between an allowing position and a restricting position according to the first embodiment.

FIG. 30 is a view of a rotational driving train according to a second embodiment.

FIG. 31 is a view of a conveyance roller drive train according to a third embodiment.

### DESCRIPTION OF THE EMBODIMENTS

Embodiments of the present disclosure will be described below with reference to the drawings.

### First Embodiment

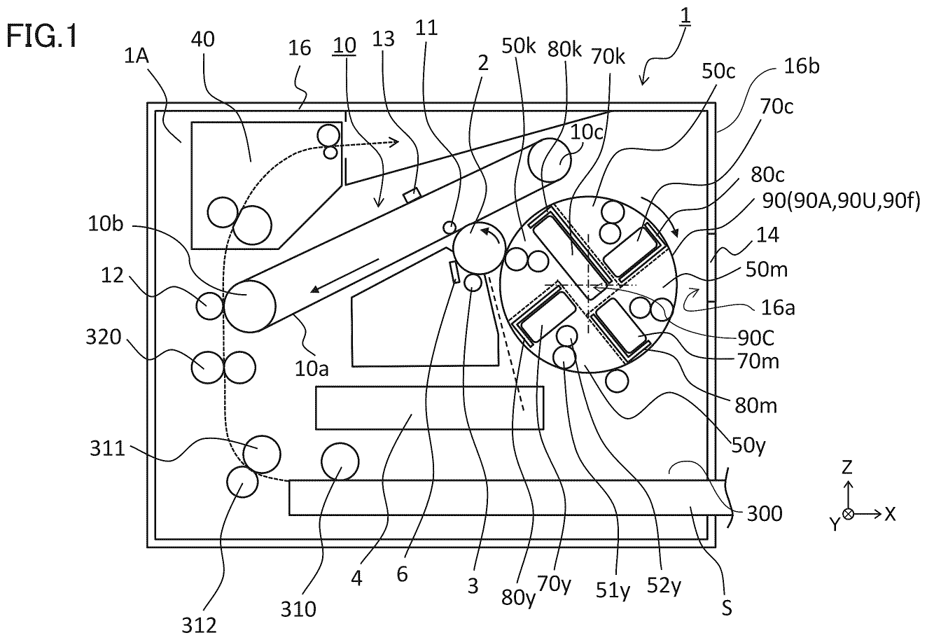

An image forming apparatus 1 according to a first embodiment will be described with reference to FIGS. 1 to 12B. In the following description and respective drawings, a vertical direction in a state where the image forming apparatus 1 is installed on a horizontal plane is referred to as a Z direction. A direction intersecting the Z direction and corresponding to a direction of a rotational axis 90C of a rotary body 90 described below, i.e., a rotational axis direction of a rotary, is referred to as a Y direction. Further, a direction of a rotational axis of a photosensitive drum 2, i.e., rotational axis direction of the photosensitive drum, is parallel with a direction of the rotational axis 90C of the rotary body 90, and it is also referred to as the Y direction. A direction intersecting both the Z direction and the Y direction is referred to as an X direction. The X direction and the Y direction are preferably a horizontal direction. The X, Y, and Z directions are preferably orthogonal to each other. Further, the directions of arrows X, Y, and Z illustrated in the respective drawings are each referred to as +X side, +Y side, and +Z side, and the opposite sides thereof are each referred to as −X side, −Y side, and −Z side, as needed. Overall Configuration of Image Forming Apparatus

At first, an overall configuration of the image forming apparatus 1 will be described. The image forming apparatus 1 is a laser beam printer that forms images on sheets S by an electrophotographic system. More specifically, the image forming apparatus 1 is a color laser beam printer equipped with four developing units 50y, 50m, 50c, and 50k. Various sheet materials having different sizes and formed of different materials may be used as the sheet S serving as a recording material, or recording medium, including paper such as normal paper and thick paper, plastic films, cloths, sheet materials subjected to surface treatment such as coated paper, and sheet materials of special shapes such as envelopes and index paper.

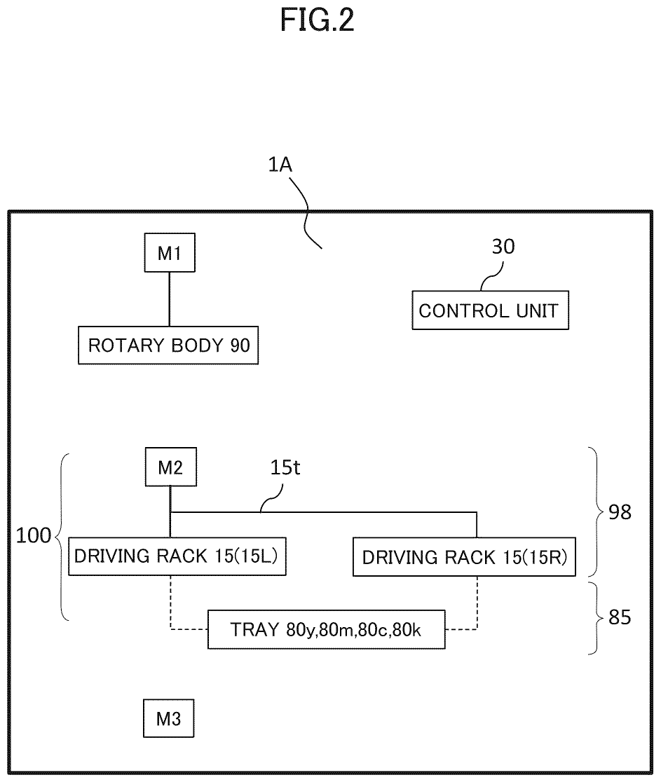

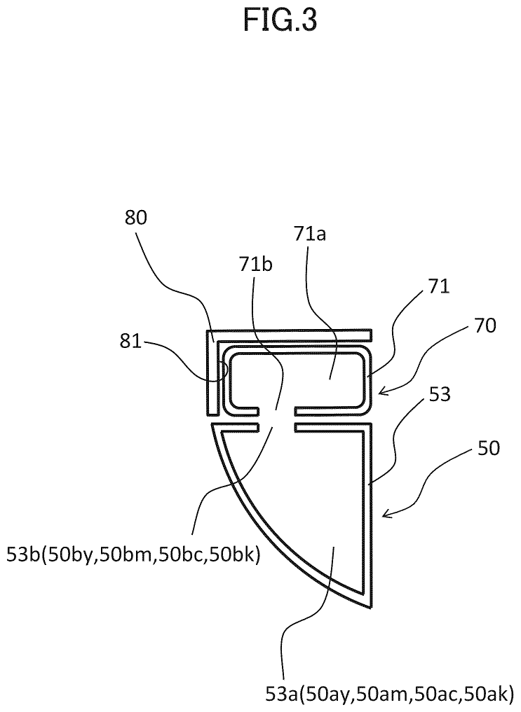

A schematic configuration of the image forming apparatus 1 and an image forming operation thereof will be described with reference to FIGS. 1, 2, and 3. FIG. 1 is a schematic view illustrating a cross-sectional configuration of the image forming apparatus 1. FIG. 2 is a view illustrating a drive source of the image forming apparatus 1. FIG. 3 is a conceptual diagram illustrating a configuration of supplying toner from a toner cartridge 70 to a developing unit 50.

As illustrated in FIG. 1, the image forming apparatus 1 includes an image forming apparatus body, hereinafter referred to as apparatus body, 1A, and toner cartridges 70y, 70m, 70c, and 70k that may be attached to and detached from the apparatus body 1A. The apparatus body 1A according to the present embodiment is the portion of the image forming apparatus 1 excluding the toner cartridges 70y, 70m, 70c, and 70k.

The apparatus body 1A of the image forming apparatus 1 includes an electrophotographic photosensitive member, hereinafter referred to as photosensitive drum, 2 having a drum shape, i.e., cylindrical shape, as an image bearing member that bears the electrostatic latent image. In the circumference of the photosensitive drum 2 are arranged a charging roller 3, a scanner 4 serving as an exposing unit, and a cleaning unit 6.

The charging roller 3 is an example of a charging unit for charging the photosensitive drum 2 uniformly. The scanner 4 is an exposing unit for irradiating the photosensitive drum 2 with a laser light based on an image information. By irradiating laser light on the photosensitive drum 2 that has been charged, an electrostatic latent image is formed on the surface of the photosensitive drum 2. The cleaning unit 6 is an example of a cleaning portion that removes toner remaining on the surface of the photosensitive drum 2.

Further, the apparatus body 1A includes a sheet storage portion 300, a pickup roller 310, a feed roller 311, a separation roller 312, a conveyance roller pair 320, a secondary transfer roller 12, a fixing unit 40, and an intermediate transfer unit 10. The pickup roller 310 is an example of a sheet feeding unit that feeds sheets S. The feed roller 311 and the separation roller 312 are an example of a separating and conveying unit that separates the sheets S one by one by frictional force and conveys the same. The secondary transfer roller 12 is an example of a transfer unit that transfers an image from an intermediate transfer belt 10a to the sheet S.

The intermediate transfer unit 10 includes the intermediate transfer belt 10a, a belt driving roller 10b, a tension roller 10c, a cleaning device 13, and a primary transfer roller 11. The intermediate transfer belt 10a is an example of an intermediate transfer body that bears the image transferred, i.e., primarily transferred, from the photosensitive drum 2 and transfers, i.e., secondarily transfers, the image onto the sheet S. The intermediate transfer belt 10a is stretched across the belt driving roller 10b and the tension roller 10c. The belt driving roller 10b is a driving member that conveys the intermediate transfer belt 10a by being rotated by the drive source.

Further, the apparatus body 1A includes a rotary body, i.e., rotary, rotating body, or developing apparatus, 90 including the developing units 50y, 50m, 50c, and 50k. As described below, according to the present embodiment, trays, i.e., support members, 80y, 80m, 80c, and 80k are attached to the rotary body 90. The toner cartridges 70y, 70m, 70c, and 70k are removably attached to the trays 80y, 80m, 80c, and 80k.

In the following description, a plurality of members having similar functions may be distinguished by assigning numbers thereto. For example, one of the toner cartridges 70y, 70m, 70c, and 70k may be referred to as a first toner cartridge, one of the remaining three may be referred to as a second toner cartridge, one of the remaining two may be referred to as a third toner cartridge, and the remaining one may be referred to as a fourth toner cartridge. Similarly, one of the trays 80y, 80m, 80c, and 80k may be referred to as a first tray, one of the remaining three may be referred to as a second tray, one of the remaining two may be referred to as a third tray, and the remaining one may be referred to as a fourth tray. That is, one of the trays 80y to 80k is an example of a first support member, another one of the trays 80y to 80k is an example of a second support member, yet another one of the trays 80y to 80k is an example of a third support member, and the final one of the trays 80y to 80k is an example of a fourth support member. The numbering is merely used for the sake of convenience of description, and can be interchanged arbitrarily in principle.

The developing units, i.e., first to fourth developing units, 50y, 50m, 50c, and 50k are each an example of a developing unit or developing portion that develops or visualizes the electrostatic latent image formed on the photosensitive drum 2 into a toner image using toner of corresponding colors. The developing units 50y, 50m, 50c, and 50k respectively develop the electrostatic latent images formed on the photosensitive drums 2 using yellow toner, magenta toner, cyan toner, or black toner. The developing units 50y, 50m, 50c, and 50k may be arranged in orders that differ from the order illustrated in FIG. 1.

The developing unit 50y includes a developing roller 51y, a feed roller 52y, and a developing blade. The developing roller 51y is a developer bearing member that rotates while bearing toner serving as a developer, and supplies the toner to the photosensitive drum 2. The feed roller 52y is a supplying member that is arranged in contact with the developing roller 51y and that supplies toner to the developing roller 51. The developing blade restricts a thickness of a toner layer borne on the developing roller 51y. The other developing units 50m, 50c, and 50k similarly include the developing rollers 51m, 51c, and 51k, feed rollers 52m, 52c, and 52k, and developing blades.

The toner cartridges 70y, 70m, 70c, and 70k corresponding to the developing units 50y, 50m, 50c, and 50k are attached to the rotary body 90. Each the toner cartridges 70y, 70m, 70c, and 70k stores yellow toner, magenta toner, cyan toner, or black toner respectively therein as toner to be supplied to the developing units 50y, 50m, 50c, and 50k. Among the four color toners, one may be referred to as a first toner, another one of the remaining three color toners may be referred to as a second toner, another one of the remaining two color toners may be referred to as a third toner, and the final toner may be referred to as a fourth toner. For example, black toner may be an example of a first toner, and magenta toner may be an example of a second toner. This numbering is merely used for the sake of convenience of description, and can be interchanged arbitrarily in principle.

The rotary body 90 includes a rotary frame 90f that supports the developing units 50y, 50m, 50c, and 50k. The developing units 50y, 50m, 50c, and 50k are supported on the rotary frame 90f, which is a rotatable rotary support body.

The trays 80y, 80m, 80c, and 80k are attached to the rotary body 90. The portion including both the rotary body 90 and the trays 80y, 80m, 80c, and 80k may be referred to as a rotary unit 90U. In other words, the rotary unit 90U includes the rotary body 90 and the trays 80y, 80m, 80c, and 80k.

The toner cartridges 70y to 70k are held in an attachable/detachable manner on the trays 80y to 80k. As described below, the trays 80y to 80k are supported slidably to an outside of the rotary body 90. The portion including both the rotary unit 90U and the toner cartridges 70y, 70m, 70c, and 70k may be referred to as a rotary assembly 90A. In other words, the rotary assembly 90A includes the rotary unit 90U and the toner cartridges 70y, 70m, 70c, and 70k.

As described below, the rotary body 90 is rotatable about a rotational axis, i.e., center of rotation, 90C. The rotational axis 90C corresponds to the rotational axis of the rotary frame 90f, the rotary unit 90U, and the rotary assembly 90A. Further, the rotational axis 90C is approximately parallel with the rotational axis, i.e., center of rotation, of the photosensitive drum 2.

The rotary body 90 may take a developing posture in which one of the developing rollers 51y, 51m, 51c and 51k face the photosensitive drum 2 by rotating about the rotational axis 90C. A posture in which the developing roller 51y faces the photosensitive drum 2 is referred to as a yellow developing posture. A posture in which the developing roller 51m faces the photosensitive drum 2 is referred to as a magenta developing posture. A posture in which the developing roller 51c faces the photosensitive drum 2 is referred to as a cyan developing posture. A posture in which the developing roller 51k faces the photosensitive drum 2 is referred to as a black developing posture. That is, the rotary body 90 may rotate about the rotational axis 90C such that the positions of the developing rollers 51y, 51m, 51c and 51k with respect to the photosensitive drum 2 vary. The black developing posture is an example of a first developing posture in which the first developing roller, i.e., the developing roller 51k, faces the photosensitive drum 2. The other developing postures are examples of a second developing posture in which a second developing roller, i.e., the developing rollers 51y to 51c, face the photosensitive drum 2. The yellow/magenta/cyan/black developing postures may also be referred to as first to fourth developing postures. This numbering is merely used for the sake of convenience of description, and can be interchanged arbitrarily in principle.

As illustrated in FIG. 2, the apparatus body 1A includes motors M1, M2, and M3 serving as drive sources. As described below, the motor M1 serving as a first motor supplies driving force to cause the rotary body 90 to rotate about the rotational axis 90C. In other words, the motor M1 causes the rotary assembly 90A and the rotary unit 90U to rotate about the rotational axis 90C.

Further, the apparatus body 1A includes a driving device 98 including the motor M2 and a transmission device. The transmission device includes driving racks 15L and 15R serving as driving gears described below, and a transmission portion 15t. The driving force of the motor M2 serving as a second motor is transmitted to the driving racks 15L and 15R by the transmission portion 15t. In other words, the motor M2 is configured to drive the driving racks 15L and 15R, and moves the trays 80y, 80m, 80c, and 80k with respect to the rotary body 90 via the driving racks 15L and 15R.

The motor M3 drives members other than the members driven by the motor M1 and the motor M2. For example, the motor M3 drives the photosensitive drum 2, the developing units 50y, 50m, 50c, and 50k, the pickup roller 310, the feed roller 311, the conveyance roller pair 320, the secondary transfer roller 12, the belt driving roller 10b, and the fixing unit 40.

The members being driven by the motors M1, M2, and M3 may be varied arbitrarily. Further, the role of any two or all three of the motors M1, M2, and M3 may be integrated in one motor. Alternatively, a drive source other than the motors M1, M2, and M3 may also be added.

Further, the apparatus body 1A includes a control unit 30 serving as a control unit for controlling the operations of the image forming apparatus 1. The control unit 30 includes a CPU for executing programs, and a storage portion such as a ROM or a RAM. The CPU reads and executes programs stored in the storage portion, and controls the operation of actuators such as the motors M1, M2, and M3 provided in the image forming apparatus 1. The storage portion includes a nonvolatile storage medium and a volatile storage medium, and functions not only as a storage space for storing programs data but also as a workspace for the CPU to execute programs. The respective functions of the control unit 30 described below may be implemented in a circuit within the control unit 30 as an independent hardware, such as ASIC.

Suffixes y, m, c, and k attached to the developing units 50y, 50m, 50c, and 50k, the toner cartridges 70y, 70m, 70c, and 70k, and the trays 80y, 80m, 80c, and 80k indicate toner colors. The basic configurations and functions of the developing units 50y, 50m, 50c, and 50k are the same. The basic configurations and functions of the toner cartridges 70y, 70m, 70c, and 70k are the same. Further, the basic configurations and functions of the trays 80y, 80m, 80c, and 80k are the same. Therefore, if there is no need to distinguish them, the suffixes y, m, c, and k may be omitted, and they may be described as an arbitrary one of the four units, cartridges, or trays. Further, if there is a need to distinguish each of the four units, cartridges, and trays, the suffixes y, m, c, and k will be assigned, such that each may be distinguished as a specific one corresponding to the added suffix among the four units, cartridges, and trays.

As illustrated in FIG. 3, the toner cartridge 70 includes a toner frame 71. The toner frame 71 includes a toner storage portion (tone storage chamber) 71a storing toner, and a discharge opening 71b communicated with the toner storage portion 71a.

The developing unit 50 includes a developing frame, i.e., storage frame, 53, and is configured to allow the toner cartridge 70 to be attached thereto. The developing frame 53 includes a developing-side storage portion 53a, i.e., storage portion, and an inlet opening 53b communicated with the developing-side storage portion, i.e., toner supplying chamber, 53a. That is, the rotary body 90 includes the developing frame 53y, the developing frame 53m, the developing frame 53c, and the developing frame 53k. That is, the rotary body 90 includes a first developing chamber, a second developing chamber, a third developing chamber, and a fourth developing chamber. As described above, the developing unit 50 includes the developing roller 51 and the feed roller 52, but these members are not shown in FIG. 3.

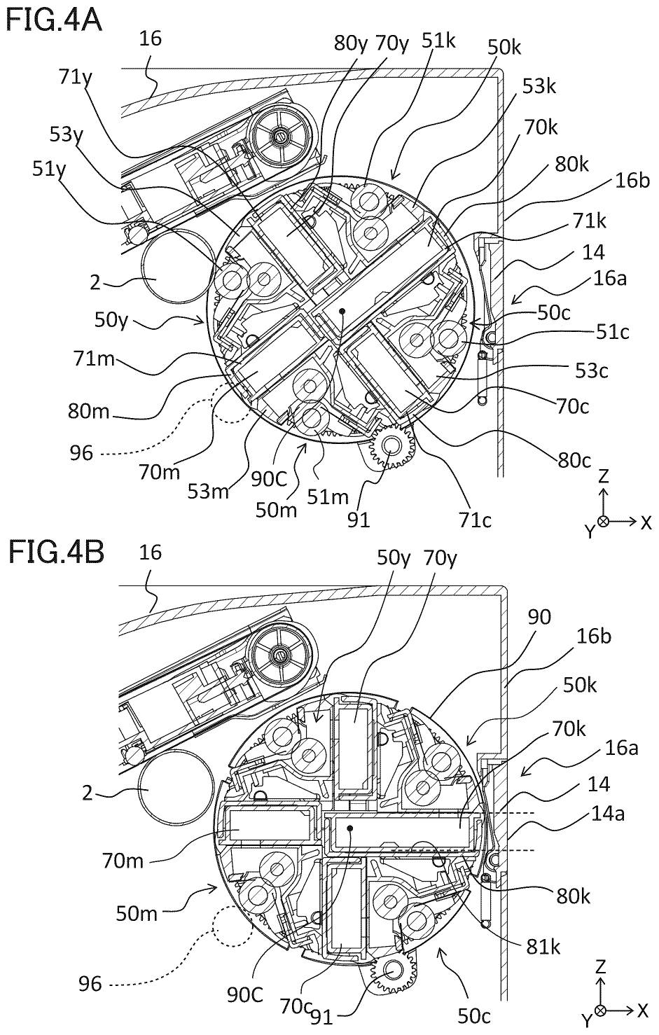

The developing roller 51k included in the developing unit 50k is an example of a first developing roller. The developing roller 51m included in the developing unit 50m is an example of a second developing roller. The developing frame 53k (FIG. 4A) of the developing unit 50k including the developing-side storage portion 53a, i.e., first storage portion, is an example of a first storage frame including the first storage portion. The developing frame 53m (FIG. 4A) of the developing unit 50m including the developing-side storage portion 53a, i.e., second storage portion, is an example of a second storage frame including the second storage portion. The rotary body 90 is an example of a rotary capable of rotating and including the first developing roller, the second developing roller, the first storage frame including the first storage portion, and the second storage frame including the second storage portion. In the present embodiment, the rotary body 90 includes first to fourth developing rollers and first to fourth storage frame bodies.

As described below, the toner cartridge 70 is movable between an attached position and a retracted position retracted from the attached position with respect to the developing frame 53. In a state where the toner cartridge 70 is at an attached position with respect to the developing frame 53, the discharge opening 71b faces the inlet opening 53b. In other words, the toner storage portion 71a of the toner cartridge 70 and the developing-side storage portion 53a of the developing unit 50 are communicated via the discharge opening 71b and the inlet opening 53b. In a state where toner is supplied from the toner cartridge 70 to the developing unit 50, at least a portion of the inlet opening 53b is positioned below at least a portion of the discharge opening 71b.

Then, toner stored in the toner storage portion 71a is discharged through the discharge opening 71b, and toner discharged through the discharge opening 71b is stored via the inlet opening 53b in the developing-side storage portion 53a. That is, a first developer is supplied to the first developing chamber included in the rotary body 90, a second developer is supplied to the second developing chamber, a third developer is supplied to the third developing chamber, and a fourth developer is supplied to the fourth developing chamber.

Toner stored in the developing-side storage portion 53a is supplied to the developing roller 51 by the feed roller 52. The toner stored in the toner storage portion 71a through the above-described route is supplied to the developing roller 51.

The toner cartridge 70 preferably includes a sealing member, i.e., first sealing member, not shown that covers the discharge opening 71b. Further, the developing unit 50 preferably includes a sealing member, i.e., second sealing member, not shown that covers the inlet opening 53b.

In a state where the toner cartridge 70 is not attached to the developing unit 50, it is preferable that the discharge opening 71b and the inlet opening 53b are each covered by a sealing member such that leakage of toner through the discharge opening 71b and the inlet opening 53b is suppressed. Image Forming Operation

An image forming operation according to the present embodiment will be described. At first, the photosensitive drum 2 is rotated in an arrow direction in FIG. 1, i.e., counterclockwise direction, in synchronization with the rotation of the intermediate transfer belt 10a. Then, the surface of the photosensitive drum 2 is charged uniformly by the charging roller 3.

When forming a color image on the sheet S, as described below, the rotary body 90 rotates in the arrow direction in FIG. 1, i.e., clockwise direction, while supporting the developing units 50y, 50m, 50c, and 50k. Then, the developing rollers 51y, 51m, 51c and 51k are moved to the developing position one by one, and electrophotographic processes are repeatedly performed.

At first, laser light based on an image data corresponding to a yellow image is irradiated from the scanner 4, and an electrostatic latent image corresponding to the yellow image is formed on the surface of the photosensitive drum 2. In parallel with the formation of the electrostatic latent image, the motor M1 rotates the rotary body 90, such that the rotary body 90 takes the yellow developing posture. When the rotary body 90 takes the yellow developing posture, the developing roller 51y is at the developing position, and the electrostatic latent image formed on the photosensitive drum 2 is developed with yellow toner.

In the present embodiment, each of the developing rollers 51y, 51m, 51c and 51k is an elastic roller formed by covering a metal shaft with rubber. At the developing position, each of the developing rollers 51y, 51m, 51c and 51k develop the electrostatic latent image in a state in contact with the photosensitive drum 2. That is, the image forming apparatus 1 according to the present embodiment adopts a contact developing system. However, in the developing position, each of the developing rollers 51y, 51m, 51c and 51k may develop the electrostatic latent image with a gap formed between the developing roller and the photosensitive drum 2. In other words, the image forming apparatus 1 may adopt a noncontact developing system.

When the yellow toner image is developed, the yellow toner image on the photosensitive drum 2 is primarily transferred to the intermediate transfer belt 10a by the primary transfer roller 11 arranged on the inner side of the intermediate transfer belt 10a.

Thereafter, by rotating the rotary body 90 and moving the developing rollers 51m, 51c, and 51k sequentially to their developing positions, the toner images of respective colors are formed. That is, after the yellow toner image is formed on the intermediate transfer belt 10a, the rotary body 90 takes the magenta developing posture, and a magenta toner image is formed on the intermediate transfer belt 10a. After the magenta toner image is formed on the intermediate transfer belt 10a, the rotary body 90 takes the cyan developing posture, and a cyan toner image is formed on the intermediate transfer belt 10a. After the cyan toner image is formed on the intermediate transfer belt 10a, the rotary body 90 takes the black developing posture, and the black toner image is formed on the intermediate transfer belt 10a. After the black toner image is formed on the intermediate transfer belt 10a, the rotary body 90 rotates in the arrow direction in FIG. 1, i.e., clockwise direction, about the rotational axis 90C, and returns to the yellow developing posture. The image color formed first on the intermediate transfer belt 10a is arbitrary, and for example, the black toner image may be formed first.

A color image is formed on the intermediate transfer belt 10a by repeating the primary transfer such that toner images of four colors are superposed on the intermediate transfer belt 10a. While forming a color image on the intermediate transfer belt 10a, the secondary transfer roller 12 and the cleaning device 13 are not in contact with the intermediate transfer belt 10a.

Meanwhile, the sheet S is fed by the pickup roller 310 from the sheet storage portion 300 arranged at a lower portion of the apparatus body 1A. The sheet S is separated one by one by the feed roller 311 and the separation roller 312 and sent to the conveyance roller pair 320. The conveyance roller pair 320 sends the sheet S being fed thereto toward a transfer portion, i.e., secondary transfer portion, which is a nip portion between the intermediate transfer belt 10a and the secondary transfer roller 12. The color image on the intermediate transfer belt 10a is transferred, i.e., secondarily transferred, to the surface of the sheet S being conveyed.

The sheet S having the color image transferred thereto is sent to the fixing unit 40. In the fixing unit 40, the sheet S is heated and pressed, and the image is fixed to the sheet S. The sheet S having passed through the fixing unit 40 is discharged as a product to the outside of the image forming apparatus 1.

Meanwhile, when forming a monochrome image on the sheet S, the rotary body 90 takes the black developing posture. In this state, an electrostatic latent image is formed on the surface of the photosensitive drum 2 by charging and exposing the photosensitive drum 2, and thereafter, the electrostatic latent image is developed by black toner by the developing roller 51k positioned at the developing position. The black toner image is primarily transferred to the intermediate transfer belt 10a, and then secondarily transferred onto the sheet S. The subsequent steps are similar to the color image. Rotary Configuration

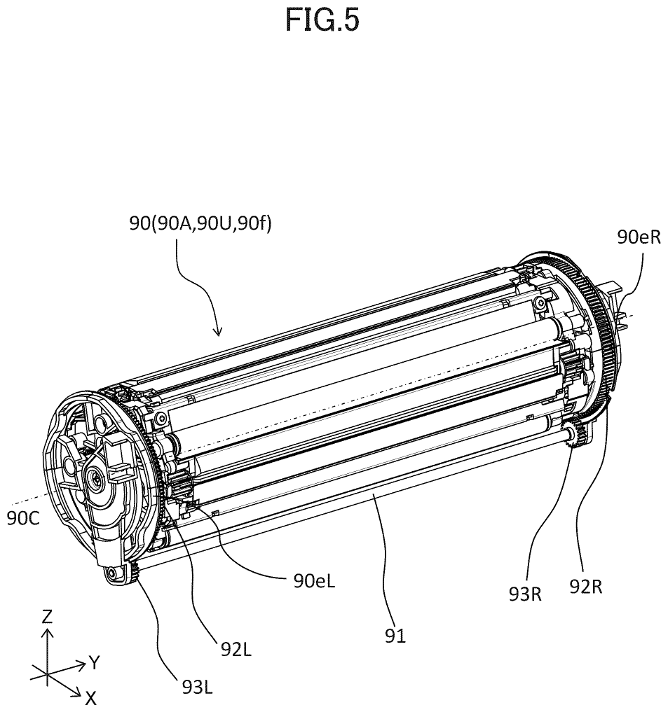

A configuration of the rotary body 90 will be described with reference to FIGS. 1, 4A, 4B, and 5. FIGS. 4A and 4B are each a cross-sectional view illustrating the rotary body 90 and a circumference of the image forming apparatus 1. FIGS. 4A and 4B are each a cross-sectional view in which the apparatus is cut at a virtual plane perpendicular to the rotational axis 90C of the rotary body 90. FIG. 5 is a perspective view of the rotary body 90.

As described above, the toner cartridges 70y to 70k are attachable to and detachable from the rotary body 90. When toner in the toner cartridges 70y to 70k are used up, the user may replace the toner cartridges 70y to 70k to replenish toner to the image forming apparatus 1.

As illustrated in FIG. 1, the apparatus body 1A includes a frame 16 accommodating the rotary body 90. The frame 16 is a main frame of the image forming apparatus 1 according to the present embodiment. The frame 16 is a casing, or housing, of the apparatus body 1A composed of frames and exterior members, and in the present embodiment, it has an approximately rectangular parallelepiped shape.

The frame 16 includes an opening 16a. More specifically, the frame 16 includes a side surface 16b that extends in a direction intersecting the horizontal direction. The side surface 16b constitutes at least a portion of an exterior surface of the apparatus body 1A on the +X side. The opening 16a is arranged on the side surface 16b. The side surface 16b is a side surface arranged on a downstream side of a sheet discharge port in a direction in which the sheet S on which the image has been formed is discharged through the sheet discharge port of the apparatus body 1A. The user may access the sheet storage portion 300 from the surface 16b side of the image forming apparatus 1 to replenish sheets S or acquire the sheets S discharged through the sheet discharge port. Therefore, the side surface 16b may be referred to as a front side of the apparatus body 1A.

The toner cartridges 70y, 70m, 70c, and 70k may be attached to and detached from the rotary body 90 through the opening 16a. That is, the toner cartridge 70k may be referred to as an example of a first toner cartridge that stores toner to be supplied to the first developing roller, i.e., the developing roller 51k, and that may be attached to and detached from the rotary, i.e., rotary body 90, through the opening 16a of the frame 16 of the apparatus body 1A. The toner cartridge 70m is an example of a second toner cartridge that may be referred to as an example of a second toner cartridge that stores toner to be supplied to the second developing roller, i.e., the developing roller 51m, and that may be attached to and detached from the rotary, i.e., rotary body 90, through the opening 16a of the frame 16 of the apparatus body 1A.

In the present embodiment, the toner cartridges 70y, 70m, 70c, and 70k are attached to and detached from the rotary body 90 through the opening 16a in a state supported by the trays 80y to 80k. In other words, the user may attach and detach the toner cartridges 70y to 70k with respect to the rotary body 90 via the trays 80y to 80k.

The opening 16a is disposed on the side surface 16b of the frame 16. In the present embodiment, the side surface 16b is a surface approximately parallel to the rotational axis 90C of the rotary body 90. Therefore, when replacing the toner cartridge 70, the toner cartridge 70 passes through the opening 16a in a direction intersecting the rotational axis 90C, preferably, in a direction orthogonal thereto.

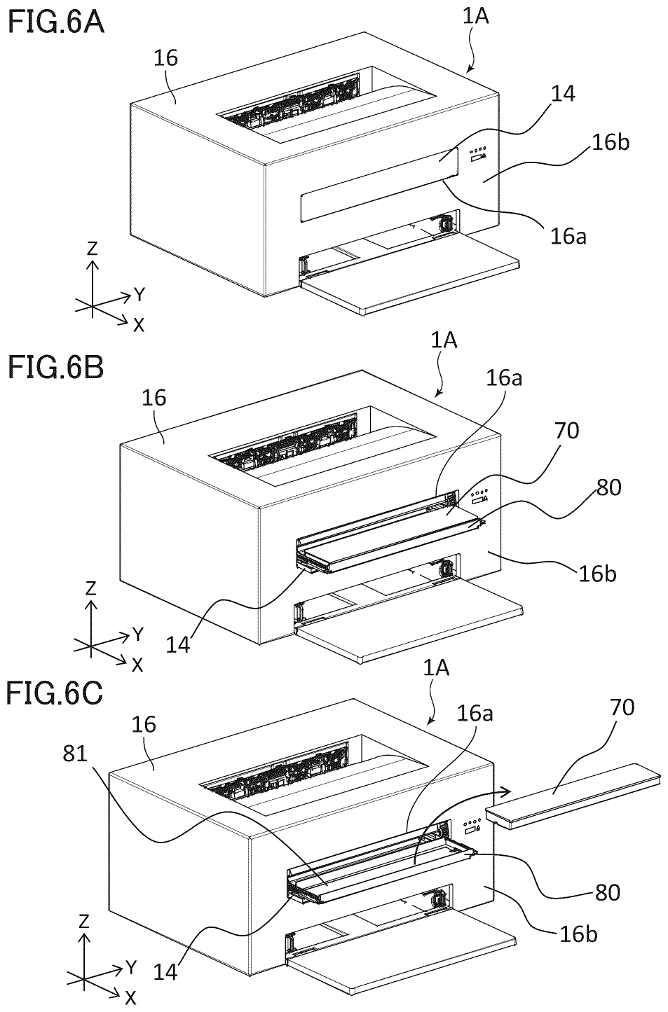

The image forming apparatus 1 includes a door 14 that covers the opening 16a of the frame 16. The door 14 is an opening/closing member that may be moved between a closed position where the opening 16a is covered (refer also to FIG. 6A), and an open position where the opening 16a is exposed (refer also to FIGS. 6B and 6C).

As described above, according to the present embodiment, the toner cartridge 70 is configured to be attached to and detached from the rotary body 90 via a tray 80. Therefore, the toner cartridge 70 may be attached to and detached from the rotary body 90 stably.

More specifically, the user may replace the toner cartridge 70 by an operation of attaching and detaching the toner cartridge 70 to and from the tray 80 that is configured movably with respect to the rotary body 90, that is, with respect to the apparatus body 1A. In a configuration where the user replaces the toner cartridge by directly inserting and drawing out the toner cartridge to and from the apparatus body, the user is required to insert the toner cartridge to a predetermined attached position with in the apparatus body. In the present embodiment, the tray 80 is movable in a state supporting the toner cartridge 70 such that the toner cartridge 70 moves to the attached position. Therefore, the user may replace the toner cartridge 70 by a simple operation of placing the toner cartridge 70 on the tray 80, and the operability is enhanced.

The toner cartridge 70 is configured to have a long and narrow shape with the Y direction parallel to the rotational axis 90C of the rotary body 90 set as a longitudinal direction. That is, the longitudinal dimension of the toner cartridge 70 is greater than a height and a width thereof in a cross section orthogonal to the longitudinal direction. When handling the toner cartridge 70 having such a long and narrow shape, by arranging the opening 16a on the side surface 16b of the frame 16 approximately parallel with the longitudinal direction of the toner cartridge 70, i.e., Y direction, the toner cartridge 70 may be passed through the opening 16a by a short moving distance. For example, the replacement of the toner cartridge 70 is made easier compared to a case where the toner cartridge 70 is inserted and drawn out via an opening formed on a side surface on one side, i.e., +Y side or-Y side, of the frame 16 in the longitudinal direction of the toner cartridge 70.

The rotary body 90 may rotate about the rotational axis 90C to take a replacement posture allowing one of the toner cartridges 70y to 70k to be removed from the rotary body 90. The posture that allows removal of the toner cartridge 70y is referred to as a yellow replacement posture. The posture that allows removal of the toner cartridge 70m is referred to as a magenta replacement posture. The posture that allows removal of the toner cartridge 70c is referred to as a cyan replacement posture.

The posture that allows removal of the toner cartridge 70k is referred to as a black replacement posture. The black replacement posture is an example of a first replacement posture that allows removal of the first toner cartridge from the rotary body 90. The yellow, magenta, and cyan replacement postures are examples of a second replacement posture that allows removal of the second toner cartridge from the rotary body 90. The yellow/magenta/cyan/black replacement postures may also be referred to as first to fourth replacement postures. This numbering is merely used for the sake of convenience of description, and can be interchanged arbitrarily in principle.

The rotary body 90 may rotate about the rotational axis 90C in a clockwise direction in FIG. 1, and sequentially take yellow/magenta/cyan/black replacement postures. In the present embodiment, by rotating the rotary body 90 about the rotational axis 90C in the clockwise direction of FIG. 1, the developing posture and the replacement posture may be switched alternatively. For example, in FIG. 1, the rotary body 90 takes the black developing posture. By the rotary body 90 rotating in the clockwise direction from this state, the posture of the rotary body 90 may be switched sequentially in the named order to the cyan replacement posture, the yellow developing posture, the black replacement posture, the magenta developing posture, the yellow replacement posture, the cyan developing posture, and the magenta replacement posture. By the rotary body 90 rotating in the clockwise direction from the magenta replacement posture, the rotary body 90 returns to the black developing posture. That is, the rotary body 90 may rotate for more than one rotation, i.e., 360°, in the clockwise direction.

FIG. 4A illustrates a cross section of the rotary body 90 in a state taking the developing posture, more specifically, the yellow developing posture. FIG. 4B illustrates a cross section of the rotary body 90 in a state taking the replacement posture, more specifically, the black replacement posture. As illustrated in FIGS. 4A and 4B, four trays 80y to 80k are attached to the rotary body 90. The toner cartridges 70y to 70k are respectively held on the trays 80y to 80k. In FIGS. 4A and 4B, the trays 80y to 80k are accommodated in the interior of the rotary body 90, and this state may be referred to as a state in which the toner cartridges 70y to 70k are attached to the developing units 50y, 50m, 50c, and 50k.

As described above, the toner cartridge 70 is movable to an attached position and a retracted position being retracted from the attached position with respect to the developing frame 53 of the developing unit 50. That is, the first toner cartridge, i.e., toner cartridge 70k, may be moved to a first attached position and a first retracted position with respect to the first storage frame, i.e., developing frame 53k. The second toner cartridge, i.e., toner cartridge 70m, may be moved to a second attached position and a second retracted position with respect to the second storage frame, i.e., developing frame 53m.

In a state where the toner cartridge 70 is in an attached position with respect to the developing frame 53, as illustrated in FIG. 3, the discharge opening 71b and the inlet opening 53b face each other. In this state, the toner cartridge 70 is configured to supply toner to the developing-side storage portion 53a through the inlet opening 53b, i.e., opening of the storage frame.

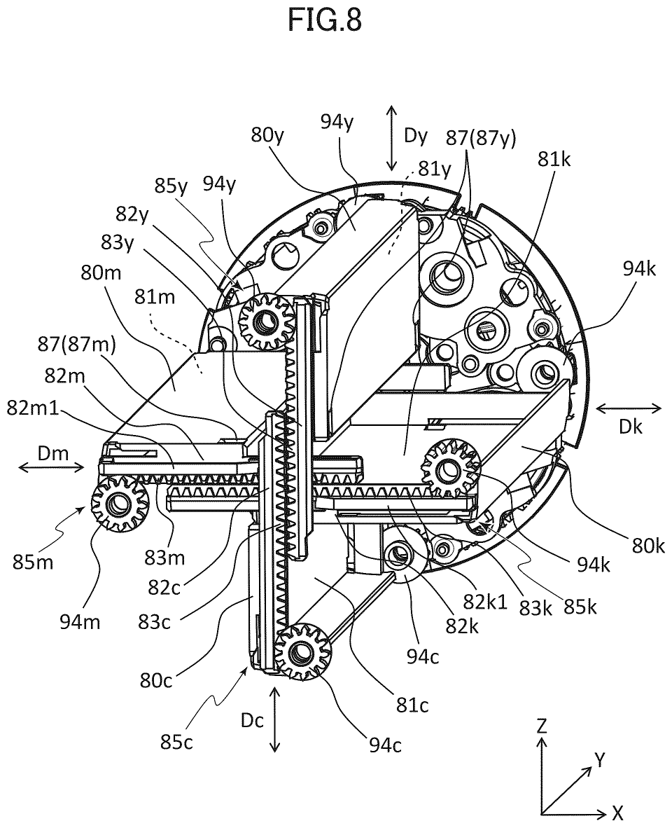

The apparatus body 1A includes a moving device 85 configured to move the toner cartridge 70 from the attached position to the retracted position with respect to the rotary body 90, more specifically, with respect to the developing frame 53 of the developing unit 50. The moving device 85 will be described below with reference to FIG. 8. In the present embodiment, a plurality of moving devices 85y to 85k corresponding to the plurality of the toner cartridges 70y to 70k are arranged in the rotary body 90. The trays 80y to 80k may be referred to as a portion of the moving devices 85y to 85k.

In the present embodiment, the toner cartridge 70k storing black toner has a size greater than the toner cartridges 70y to 70c storing yellow toner, magenta toner, and cyan toner, and may store a greater amount of toner. In other words, the first toner cartridge may store a first amount of toner, the second toner cartridge may store a second amount of toner, and the first amount is greater than the second amount.

Specifically, the length of the black toner cartridge 70k in a first radial direction with respect to the rotational axis 90C of the rotary body 90 is greater than the length of the magenta toner cartridge 70m in a second radial direction. Now, the first radial direction is a rotational radius direction of the rotary body 90, that is, a radial direction of a virtual circle having a center set to the rotational axis 90C, and it is a direction in which the toner cartridge 70k extends with respect to the rotational axis 90C when viewed in the direction of the rotational axis 90C. The second radial direction is a rotational radius direction of the rotary body 90, and it is a direction in which the toner cartridge 70m extends with respect to the rotational axis 90C when viewed in the direction of the rotational axis 90C. Similarly, the length of the black toner cartridge 70k in the first radial direction is greater than the lengths of the toner cartridges 70y and 70c in the radial direction corresponding to the other toner cartridges 70y and 70c.

Accordingly, the tray 80k that holds the black toner cartridge 70k has a greater size than that of the trays 80y to 80c holding the other toner cartridges 70y, 70m, and 70c. That is, four toner cartridges 70y to 70k and trays 80y to 80k having different sizes are disposed in the rotary body 90. In other words, the rotary body 90 allows the toner cartridge 70k serving as an example of a first toner cartridge and the toner cartridge 70y serving as an example of a second toner cartridge having a smaller size than the first toner cartridge to be attached thereto and detached therefrom. Corresponding thereto, the rotary body 90 has the tray 80k serving as an example of a first support member supporting the first toner cartridge and the tray 80y serving as an example of a second support member having a smaller size than the first support member provided therein. Further, the rotary body 90 allows the toner cartridges 70m and 70c as an example of the third toner cartridge and the fourth toner cartridge having a smaller size than the first toner cartridge to be attached thereto and detached therefrom. Corresponding thereto, the rotary body 90 has the trays 80m and 80c as examples of the third support member and the fourth support member having a size smaller than the first support member provided therein.

Now, with reference to FIG. 5, the rotational driving of the rotary body 90 will be described. As illustrated in FIG. 5, disk gears 92L and 92R are formed on respective end portions of the rotary body 90. Further, rotary driving gears 93L and 93R formed on respective end portions of a swing shaft 91 are connected in a manner capable of transmitting a driving force. The driving force of the motor M1 is transmitted to the rotary driving gear 93R via a drive transmission mechanism. Next, by having the driving force transmitted via the rotary driving gears 93L and 93R to the disk gears 92L and 92R, the rotary body 90 is driven to rotate. The rotary body 90 rotates about the rotational axis 90C in the clockwise direction in FIG. 1.

In addition, the rotary body 90 is supported so as to be swingable about the swing shaft 91. The rotary body 90 is urged in a counterclockwise direction in FIGS. 4A and 4B about the swing shaft 91 by an urging member not shown. This direction can be referred to as a direction in which the developing rollers 51y to 51k each approach the photosensitive drum 2. As a result, one of the developing rollers 51y to 51k is in contact with the photosensitive drum 2 in a state where the rotary body 90 is in a developing posture.

Meanwhile, as illustrated in FIG. 5, rotary cams 90eL and 90eR are provided on respective end portions of the rotary body 90. When the rotary body 90 rotates about the rotational axis 90C in a clockwise direction in FIGS. 4A and 4B, the rotary cams 90eL and 90eR come into contact with a roller 96 supported by the frame 16 illustrated in FIGS. 4A and 4B. Then, the rotary body 90 moves in the clockwise direction in FIGS. 4A and 4B about the swing shaft 91. This direction may be referred to as a direction in which the developing rollers 51y to 51k each move away from the photosensitive drum 2. In addition, this direction may be referred to as a direction in which the rotary body 90 approaches the opening 16a of the frame 16 and the door 14.

As a result, when the rotary body 90 rotates and switches from the developing posture to the replacement posture, the rotary body 90 swings about the swing shaft 91. In a state where the rotary body 90 is in the replacement posture, the developing roller 51 is separated from the photosensitive drum 2.

As illustrated in FIG. 4B, in the black replacement posture, the toner cartridge 70k stops at a position facing the opening 16a and the door 14 provided on the side surface 16b of the apparatus body 1A. From this state, when the tray 80k is moved to slide from the attached position of the developing unit 50k to the outside of the rotary body 90, the user may replace the toner cartridge 70k. Replacement Operation of Toner Cartridge

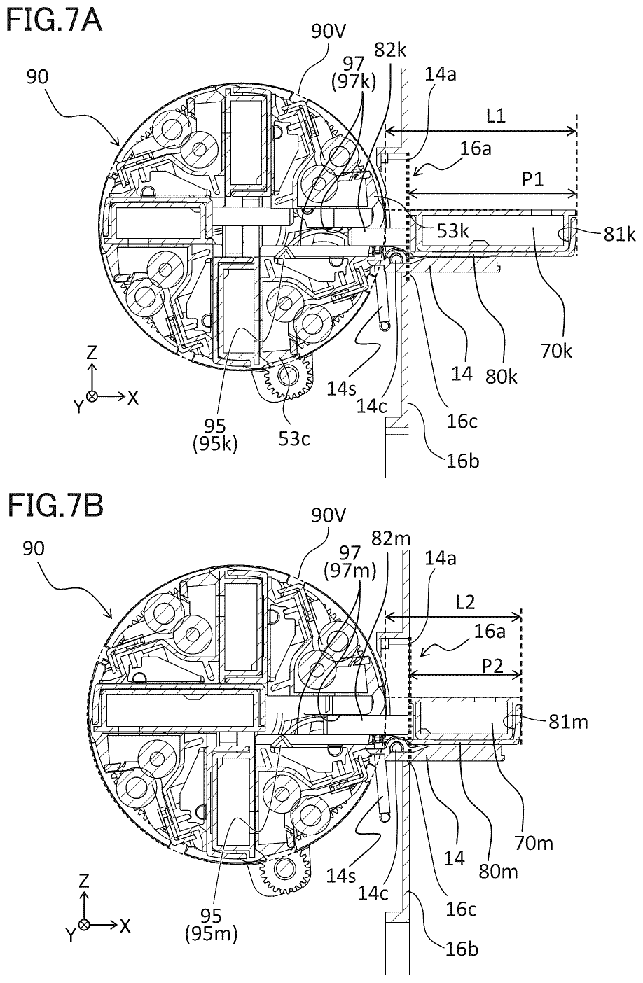

A toner cartridge replacement operation will be described with reference to FIGS. 4A, 6A to 6C, 7A, and 7B. FIGS. 6A to 6C are each an exterior view of the apparatus body 1A. FIGS. 7A and 7B are each a cross-sectional view of the rotary body 90 and the surroundings thereof in toner cartridge replacement. FIGS. 7A and 7B are each a cross-sectional view of the apparatus taken along a virtual plane perpendicular to the rotational axis 90C of the rotary body 90.

FIG. 6A illustrates an external appearance of the apparatus body 1A during the image forming operation and in a standby state. During the image forming operation refers to a period during which a series of operations of the image forming apparatus 1 of feeding a sheet S, forming an image on the sheet S, and then discharging the sheet S as a product are executed. The standby state is a state in which the image forming operation may be started if the image forming apparatus 1 receives an image forming instruction, i.e., printing instruction, and a state in which the image forming apparatus 1 is standing by for the image forming instruction from the user. As illustrated in FIG. 6A, the door 14 is in a closed state during the image forming operation and in the standby state.

FIG. 6B illustrates the external appearance of the apparatus body 1A at the time of toner cartridge replacement. At the time of toner cartridge replacement, the door 14 is in an open state, and the tray 80 and the toner cartridge 70 are moved to the outside of the apparatus body 1A.

The toner cartridge 70 is movable to an attached position and a retracted position where the toner cartridge 70 is retracted from the attached position with respect to the developing frame 53 of the developing unit 50. In a state where the toner cartridge 70 is at the attached position with respect to the developing frame 53, the discharge opening 71b and the inlet opening 53b face each other, as illustrated in FIG. 3. As illustrated in FIGS. 4A and 4B, the rotary body 90 is configured to rotate about the rotational axis 90C to take the developing posture and the replacement posture in a state where the toner cartridge 70 is at the attached position.

The toner cartridge replacement operation will be described. First, the user instructs a toner cartridge replacement operation to the control unit 30 (FIG. 2) of the apparatus body 1A. The instruction of toner cartridge replacement operation is given, for example, through an input via an operation panel, i.e., operation portion, provided on the apparatus body 1A.

When the control unit 30 receives the instruction of the toner cartridge replacement operation, the rotary body 90 rotates to the replacement posture of the toner cartridge 70 serving as a replacement target, i.e., toner cartridge 70 whose toner has run out, and stops. That is, the control unit 30 rotates the rotary body 90 to the replacement posture of a toner cartridge designated in the instruction of the toner cartridge replacement, which in FIG. 4B is the black replacement posture for replacing the black toner cartridge 70k. In the replacement posture, the tray 80 supporting the toner cartridge 70 whose replacement has been instructed faces the opening 16a of the frame 16 of the apparatus body 1A.

For example, the rotary body 90 of FIG. 4A is in the yellow developing posture in which the yellow developing roller 51y faces the photosensitive drum 2. At this time, the black toner cartridge 70k and the tray 80k do not have to face the opening 16a and the door 14. In other words, the toner cartridge 70 and the tray 80 do not have to face the opening 16a and the door 14 in the case where the rotary body 90 is in a replacement posture or a developing posture other than the replacement posture of the relevant toner cartridge. Therefore, the opening 16a may have such a size that each of the toner cartridges 70 can individually pass therethrough. When the rotary body 90 rotates in the clockwise direction in the drawings by a predetermined angle from the yellow developing operation, the black toner cartridge 70k and the tray 80k will face the opening 16a and the door 14 as illustrated in FIG. 4B.

Here, “the tray 80 facing the opening 16a” means that the tray 80 is positioned so as to be movable to the outside of the apparatus body 1A through the opening 16a. That is, in the case where the tray 80 faces the opening 16a, a moving mechanism described below moves the tray 80 outward in the rotational radius direction of the rotary body 90, and therefore, the tray 80 and the toner cartridge 70 supported by the tray 80 may be projected to the outside of the apparatus body 1A. In FIG. 4A, none of the trays 80y to 80k faces the opening 16a. In FIG. 4B, only the black tray 80k faces the opening 16a, and the other trays 80y to 80c do not face the opening 16a.

When the rotary body 90 is positioned in the replacement posture, the motor M2 moves the tray 80 supporting the toner cartridge 70 serving as a replacement target to the outside of the apparatus body 1A.

As a result, the toner cartridge 70 serving as a replacement target moves from the attached position to the retracted position with respect to the rotary body 90. In addition, as illustrated in FIGS. 6B, 6C, 7A, and 7B, the tray 80 and the toner cartridge 70 serving as a replacement target supported by the tray 80 are projected to the outside of the apparatus body 1A through the opening 16a.

More specifically, the tray 80 is movable to an accommodation position and a removal position with respect to the rotary body 90. That is, the first tray is movable to an accommodation position and a removal position with respect to the rotary body 90. Further, the second tray is movable to an accommodation position, i.e., third position, and a removal position, i.e., fourth position, with respect to the rotary body 90. The accommodation position is a position where the tray 80 is accommodated in the rotary body 90. The removal position is a position, i.e., removing position or replaceable position, where at least a portion of the tray 80 is projected, or exposed, to the exterior of the rotary body 90 and the toner cartridge 70 may be detached from the tray 80. The positions of the trays 80y to 80k in FIGS. 4A and 4B are examples of the accommodation position. The position of the tray 80 in FIGS. 6B and 6C, the position of the tray 80k in FIG. 7A, and the position of the tray 80m in FIG. 7B are examples of the removal position.

When the tray 80 is at the accommodation position, the toner cartridge 70 attached to the tray 80 is positioned inside the rotary body 90 and at the attached position. When the tray 80 is at the removal position, the toner cartridge 70 attached to the tray 80 is positioned at the exterior of the rotary body 90 and at the retracted position.

Here, as illustrated in FIGS. 7A and 7B, the rotary body 90 includes projected portions 95 that hold the tray 80 at the accommodation position and holds the toner cartridge 70 at the attached position. As illustrated in FIG. 8, the tray 80 has recess portions 87 configured to be fit to the projection portions 95. FIGS. 7A and 7B illustrate projection portions 95k and 95m corresponding to the trays 80k and 80m, and FIG. 8 illustrates recess portions 87y and 87m of the trays 80y and 80m, wherein the projection portion 95 and the recess portion 87 are provided on each of the trays 80y to 80k. The projection portion 95 is preferably urged in a direction so as to engage with the recess portion 87.

By having the projection portion 95 fit to the recess portion 87 of the tray 80, the tray 80 is locked with respect to the rotary frame 90f. As a result, the tray 80 will stay in the accommodation position even when the rotary body 90 rotates, and the toner cartridge 70 may be prevented from moving from the attached position. In the case where the tray 80 is moved between the accommodation position and the removal position by the moving device described below, the projection portion 95 may be configured to be moved by the tray 80, and thereby, the projection portion 95 may be disengaged from the recess portion 87.

In the present embodiment, the door 14 is supported so as to be pivotable with respect to the apparatus body 1A. As illustrated in FIG. 7A, the door 14 is urged from the open position to the closed position by a spring 14s. The spring 14s is, for example, a tension spring, and urges the door 14 such that a moment in a counterclockwise direction in FIGS. 7A and 7B is generated about a support shaft 14c of the door 14.

By having the tray 80 push the door 14, the door 14 will be in the open state illustrated in FIG. 6B. This state may be referred to as a state in which the tray 80 is supported by the door 14. The door 14 supports at least a portion of the tray 80 projected to the outside of the apparatus body 1A, and thus the toner cartridge 70 may be supported more stably. In other words, when the first toner cartridge, i.e., toner cartridge 70k, is at the first retracted position, the opening/closing member, i.e., door 14, at the open position supports the first support member, i.e., tray 80k. In addition, when the second toner cartridge, i.e., one of the toner cartridges 70y to 70c, is at the second retracted position, the opening/closing member, i.e., door 14, at the open position supports the second support member, i.e., one of the trays 80y to 80c.

The door 14 is configured so as to come in contact with a portion, for example, a lower edge 16c of the opening 16a, of the frame 16 of the apparatus body 1A at the open position, and so as not to pivot downward beyond the open position. When the tray 80 is drawn back into the apparatus body 1A from outside, the door 14 returns to the closed position by the urging force of the spring 14s.

The toner cartridge 70 is attachably/detachably held by the tray 80. Therefore, as illustrated in FIG. 6C, the user may perform an operation, i.e., replacement operation, of detaching the toner cartridge 70 from the tray 80 and attaching a new toner cartridge 70 thereto. When replacing a plurality of toner cartridges 70, the replacement operation may be performed by repeating the operation described above.

FIGS. 7A and 7B illustrate a cross-section of the rotary body 90 and the surroundings thereof at the time of toner cartridge replacement. FIG. 7A illustrates a state when replacing the black toner cartridge 70k. FIG. 7B illustrates a state when replacing the magenta toner cartridge 70m.

The image forming apparatus 1 includes moving devices 85y, 85m, 85c, and 85k (FIG. 8) that respectively move the toner cartridges 70y, 70m, 70c, and 70k from the attached position to the retracted position. When the term “the moving device 85” without the suffix is used, normally, it refers to an arbitrary one of the moving devices 85y, 85m, 85c, and 85k. In the present embodiment, it can be said that the moving device 85 includes the tray 80. A moving device 85k including the tray 80k may be referred to as an example of a first moving device including a first support member. A moving device 85m including the tray 80m may be referred to as an example of a second moving device including a second support member.

Even when the toner cartridge 70 is at the retracted position, the tray 80 is connected to the rotary body 90, that is, supported by the rotary body 90. To easily detach the toner cartridge 70 from the rotary body 90, it is preferable that the length by which the toner cartridge 70 projects from the rotary body 90 at the retracted position is long. Since the toner cartridge 70 is configured to be attachable to and detachable from the rotary body 90 via the tray 80, the toner cartridge 70 can be stably supported by the tray 80 even in the case where the length by which the toner cartridge 70 projects from the rotary body 90 is long.

The movement direction of the toner cartridge 70 in which the toner cartridge 70 moves from the attached position to the retracted position is referred to as a retraction direction. In the present embodiment, the retraction direction of the toner cartridge 70 is a direction intersecting the direction of the rotational axis 90C, i.e., Y direction. Therefore, as illustrated in FIGS. 7A and 7B, as viewed in the direction of the rotational axis 90C, i.e., Y direction, the retraction direction of the toner cartridge 70 is a direction orthogonal to the direction of the rotational axis 90C, i.e., Y direction. In addition, the retraction direction of the toner cartridge 70 may be referred to as a direction outward in the rotational radius direction of the rotary body 90, that is, a direction away from the rotational axis 90C.

As illustrated in FIGS. 7A and 7B, since the user detaches the toner cartridge 70 from the rotary body 90, it is preferable that at least a portion of the toner cartridge 70 projects from the rotary body 90 when detaching the toner cartridge 70. In the present embodiment, the entirety of the toner cartridge 70 projects from the rotary body 90 when the toner cartridge 70 is at the retracted position.

It can be said that when the rotary body 90 rotates about the rotational axis 90C, the rotational trajectory of the rotary body 90 coincides with a circumscribed circle of the rotary body 90 centered on the rotational axis 90C, that is, a virtual circle 90V indicated by a dashed line in FIGS. 7A and 7B. When the toner cartridge 70 is at the retracted position, half the length or more of the toner cartridge 70 in the retraction direction is preferably outside the rotational trajectory of the rotary body 90. That is, as viewed in the rotational axis direction of the rotary, half the total length or more of the toner cartridge is preferably positioned outside the rotational trajectory of the rotary in the movement direction of the toner cartridge from the attached position to the retracted position. This applies to each of the toner cartridges 70 including the toner cartridge 70k serving as an example of the first cartridge and the toner cartridge 70m serving as an example of the second cartridge. In addition, in the present embodiment, the entirety of the toner cartridge 70 is outside the rotational trajectory, i.e., virtual circle 90V, of the rotary body 90 when the toner cartridge 70 is at the retracted position, as illustrated in FIGS. 7A and 7B.

Further, to allow the user to easily grab the toner cartridge 70, at least a portion of the toner cartridge 70 is preferably positioned outside the image forming apparatus 1, that is, outside the apparatus body 1A, when the toner cartridge 70 is at the retracted position. The outside of the apparatus refers to a space that is outside the image forming apparatus 1, i.e., outside the apparatus body 1A, when the image forming apparatus 1 is used, for example, for an image forming operation on the sheet S.

In the present embodiment, the exterior surface of the apparatus body 1A is constituted by the exterior surface of the frame 16. That is, outside the apparatus can be also referred to as outside the frame 16. Therefore, a state in which at least a portion of the toner cartridge 70 is outside the apparatus can be also referred to as a state in which at least a portion of the toner cartridge 70 projects to the outside of the frame 16 through the opening 16a of the frame 16 of the apparatus body 1A.

In the present embodiment, when the door 14 is at the closed position, the opening 16a of the frame 16 of the apparatus body 1A is covered by the door 14. Further, an exterior surface 14a of the door 14 at the closed position constitutes a portion of the exterior surface of the apparatus body 1A. In this case, the outside of the apparatus refers to the outside of the exterior surface 14a of the door 14 at the closed position. That is, in the case where the position of the exterior surface 14a of the door 14 at the closed position is referred to as an exterior position, at least a portion of the toner cartridge 70 is positioned on the outer side than the exterior position with respect to the apparatus body 1A when the toner cartridge 70 is at the retracted position.

In other words, at least a portion of the toner cartridge 70 is positioned in a space serving as an outer side of the apparatus body 1A if the door 14 were at the closed position. Further, at least a portion of the toner cartridge 70 is positioned downstream of the exterior position in the retraction direction of the toner cartridge 70.

In addition, in the case where the side surface 16b having the opening 16a is at the front side of the apparatus body 1A, it can be said at least a portion of the toner cartridge 70 projects to the front side beyond the exterior surface on the front side of the apparatus body 1A when the toner cartridge 70 is at the retracted position. In this case, the user may easily access the toner cartridge 70 from the front side of the image forming apparatus and perform the replacement operation of the toner cartridge 70.

When the toner cartridge 70 is at the retracted position, half the length or more of the toner cartridge 70 in the retraction direction is preferably outside the apparatus. That is, as viewed in the rotational axis direction of the rotary, half the total length or more of the toner cartridge is preferably positioned outside the main body frame in the movement direction of the toner cartridge from the attached position to the retracted position in a state where the toner cartridge is at the retracted position. This applies to each of the toner cartridges 70 including the toner cartridge 70k serving as an example of the first toner cartridge and the toner cartridge 70m serving as an example of the second toner cartridge. In addition, the entirety of the toner cartridge 70 is preferably outside the apparatus when the toner cartridge 70 is at the retracted position. Although the exterior surface 14a of the door 14 and the side surface 16b constitute the exterior surface on the front side of the apparatus body 1A in the present embodiment, the configuration of the door 14 is not limited to this example. For example, the size of the door 14 may be set so as to cover the entirety of the side surface 16b. In this case, the exterior surface 14a of the door 14 constitutes the exterior surface on the front side of the apparatus body 1A.

The tray 80 includes a cartridge holding portion 81 illustrated in FIGS. 3 and 6C that holds the toner cartridge 70. The cartridge holding portion 81 is an attached portion to which the toner cartridge 70 is attached. When the tray 80 is at the removal position, the entirety of the cartridge holding portion 81 is preferably outside the rotational trajectory of the rotary body 90 in the retraction direction. When the tray 80 is at the removal position, half the length or more of the cartridge holding portion 81 is preferably outside the apparatus in the retraction direction.

Here, as described above, the toner cartridge 70k and the tray 80k are larger in size than the other toner cartridges 70y to 70c and the other trays 80y to 80c. Therefore, as illustrated in FIGS. 7A and 7B, in the present embodiment, the moving amount of the tray 80 in toner cartridge replacement is varied in accordance with the size of the toner cartridge 70.

Specifically, as illustrated in FIG. 7A, the moving distance of the tray 80k, i.e., first support member, from the accommodation position, i.e., first accommodation position, to the removal position, i.e., first removal position, is L1. The moving distance of the tray 80m, i.e., second support member, from the accommodation position, i.e., second accommodation position, to the removal position, i.e., second removal position, is L2. Although a state in which the toner cartridge 70m and the tray 80m are moved is illustrated in FIG. 7B, the moving distance of the trays 80y and 80c from the accommodation position to the removal position is also L2. In this case, L1 is greater than L2. In other words, it can be said that the moving distance of the first support member in the case where the first toner cartridge moves from the first attached position to the first retracted position is longer than the movement distance of the second support member in the case where the second toner cartridge moves from the second attached position to the second retracted position.

In addition, as illustrated in FIG. 7A, in a state where the tray 80k is at the removal position and the toner cartridge 70k is at the retracted position, the toner cartridge 70k projects from the exterior surface of the apparatus body 1A to the outside of the apparatus by a distance P1. In the present embodiment, the tray 80k also projects from the exterior surface of the apparatus body 1A to the outside of the apparatus by the distance P1.

In addition, as illustrated in FIG. 7B, in a state where the tray 80m is at the removal position and the toner cartridge 70m is at the retracted position, the toner cartridge 70m projects from the exterior surface of the apparatus body 1A to the outside of the apparatus by a distance P2. In the present embodiment, the tray 80m also projects from the exterior surface of the apparatus body 1A to the outside of the apparatus by the distance P2. The toner cartridges 70y and 70c also project from the exterior surface of the apparatus body 1A to the outside of the apparatus by the distance P2.

The distance P1 described above is greater than the distance P2. That is, the length by which the first toner cartridge at the first retracted position projects through the opening 16a of the apparatus body 1A will be referred to as a first length (P1), and the length by which the second toner cartridge at the second retracted position projects through the opening 16a will be referred to as a second length (P2). In this case, it can be said that the first length is longer than the second length.

It is more preferable in terms of strength that the distance P2 by which the toner cartridges 70y to 70c smaller in size than the toner cartridge 70k project to the outside of the apparatus at the retracted position is shorter than the distance P1 by which the toner cartridge 70k projects to the outside at the retracted position. The reason for this is as follows. When the toner cartridge 70 is at the retracted position, at least a portion of the toner cartridge 70 projects to the outside of the apparatus from the outside of the rotational trajectory of the rotary body 90 or the exterior surface of the apparatus body 1A. At this time, the tray 80 supports the weight of the toner cartridge 70 in a state where one side thereof is supported by the rotary body 90 in a cantilever manner. Therefore, by making the distance P2 by which the toner cartridges 70y to 70c project to the outside of the apparatus at the retracted position shorter, the load on the trays 80y to 80c or guide portions 97 of the rotary body 90 supporting the trays 80y to 80k may be reduced. In addition, since the toner cartridges 70y to 70c are smaller than the toner cartridge 70k, the operability of the cartridge replacement for the trays 80y to 80c may be maintained even if the distance P2 is set to be smaller than the distance P1.

### Tray Arrangement in Rotary

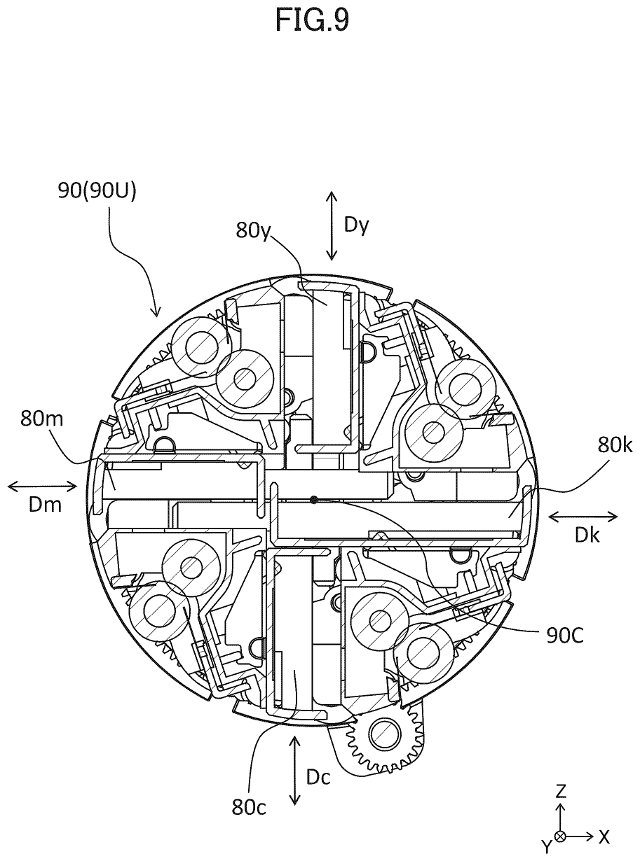

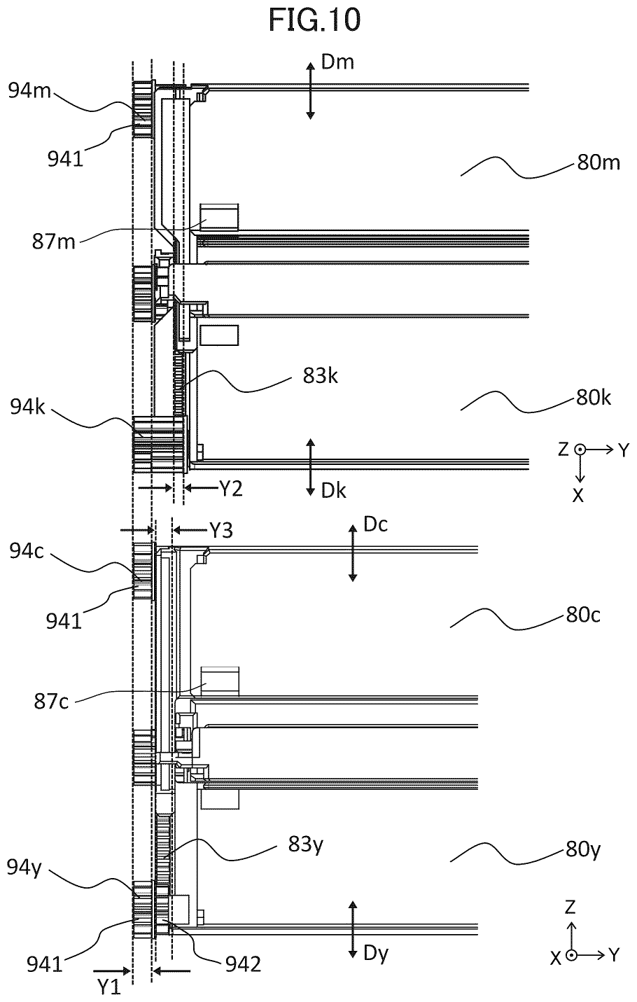

The arrangement of the trays 80y to 80k in the rotary body 90 will be described with reference to FIGS. 8, 9, and 10. FIG. 8 is a perspective view illustrating the arrangement of the trays 80y to 80k in the rotary body 90. FIG. 9 is a cross-sectional view illustrating the arrangement of the trays 80y to 80k in the rotary body 90. FIG. 10 is a diagram illustrating the member arrangement of the trays 80y to 80k on one end side in the Y direction. FIG. 9 illustrates a cross-section of the rotary body 90 taken along a virtual plane perpendicular to the rotational axis 90C of the rotary body 90. In addition, the top half of FIG. 10 is a diagram of the rotary body 90 and the trays 80m and 80k of FIG. 8 as viewed from the upper right side, i.e., +Z side, of FIG. 8, and the lower half of FIG. 10 is a diagram of the rotary body 90 and the trays 80c and 80y of FIG. 8 as viewed from the left side, i.e., −X side, of FIG. 8.

As illustrated in FIG. 8, the trays 80y to 80k are respectively provided with cartridge holding portions 81y to 81k and guided portions 82y to 82k.

The toner cartridges 70y to 70k are respectively attached to the cartridge holding portions 81y to 81k. The cartridge holding portions 81y to 81k respectively accommodate at least a portion of the toner cartridges 70y to 70k attached thereto.

The guided portions 82y to 82k are provided at respective end portions of the trays 80y to 80k such that the cartridge holding portions 81y to 81k are each interposed therebetween in the Y direction. The guided portions 82y to 82k are each a long and narrow member extending in a direction orthogonal to the rotational axis of the rotary body 90.

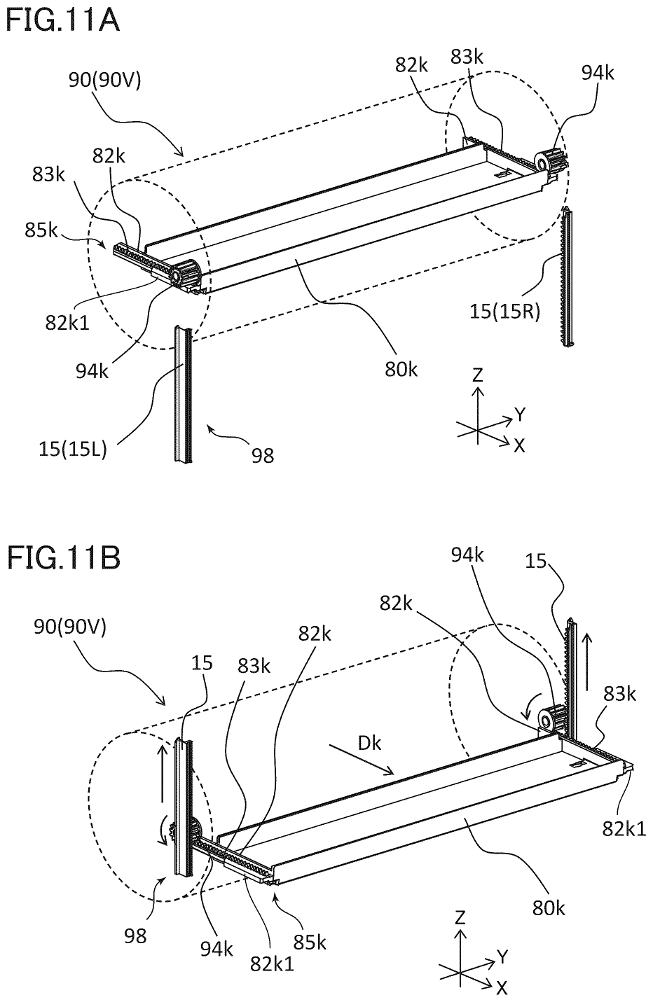

In the present embodiment, a reinforcing rib 82k1 is formed on a portion of the guided portion 82k in a movement direction Dk of the tray 80k, and a reinforcing rib 82m1 is formed on a portion of the guided portion 82m in a movement direction Dm of the tray 80m, as illustrated in FIGS. 11A and 11B. The reinforcing ribs 82k1 and 82m1 are long and narrow ribs, i.e., ridges, projecting outward in the Y direction from the guided portions 82k and 82m of the respective end portions of the trays 80k and 80m in the Y direction and extending in the movement directions Dk and Dm of the trays 80k and 80m. The reinforcing ribs 82k1 and 82m1 enhance the stiffness of the guided portions 82k and 82m.

In the present embodiment, the lengths of the reinforcing ribs 82m1 and 82k1 are restricted so as to avoid the guided portions 82y and 82c, but the reinforcing ribs 82m1 and 82k1 may be provided to cover the entire lengths of the guided portions 82m and 82k if interference with the guided portions 82y and 82c will not occurs. Reinforcing ribs may be added to the guided portions 82y and 82c. In addition, in the case where the stiffness of the guided portions 82m and 82k is sufficient, a configuration in which the reinforcing ribs 82m1 and 82k1 are not provided may be employed.

The guided portions 82y to 82k have rack portions 83y to 83k, i.e., rack gears, formed therein. In addition, pinion gears 94y to 94k are rotatably held in the rotary body 90. The pinion gears 94y to 94k are respectively engaged with the rack portions 83y to 83k in a manner capable of transmitting a driving force.

The tray 80y is provided with one or more rack portions 83y. The rotary body 90 is provided with one or more pinion gears 94y corresponding to one or more rack portions 83y. Similarly, each of the tray 80m, the tray 80c, and the tray 80k is provided with one or more rack portions 83m, one or more rack portions 83c, and one or more rack portions 83k, respectively. The rotary body 90 is provided with one or more pinion gears 94m, one or more pinion gears 94c, and one or more pinion gears 94k each corresponding to the one or more rack portions 83m, the one or more rack portions 83c, and the one or more rack portions 83k.

The rack portions 83y to 83k and the pinion gears 94y to 94k are a portion of the moving devices 85y to 85k configured to move the toner cartridges 70y to 70k from the attached position to the retracted position. In addition, it can be said that the rack portions 83y to 83k and the pinion gears 94y to 94k are a portion of a driven device driven by the driving device 98 of the apparatus body 1A. It can be said that the pinion gears 94y to 94k are rotatable bodies, i.e., rotation members, that rotate to move the trays 80y to 80k with respect to the rotary body 90.

The moving devices 85y to 85k are driven by the driving device 98 of the apparatus body 1A. The pinion gears 94y to 94k and the rack portions 83y to 83k function as driven portions for the moving devices 85y to 85k of the rotary body 90 to receive the driving force from the driving device 98 of the apparatus body 1A. The pinion gear 94k and the rack portion 83k are examples of a first pinion gear and a first rack gear constituting at least a portion of a first driven portion included in a first moving device. The pinion gear 94m and the rack portion 83m are examples of a second pinion gear and a second rack gear constituting at least a portion of a second driven portion included in a second moving device.

The rotary body 90 includes guide portions 97 illustrated in FIGS. 7A and 7B that respectively engage with the guided portions 82y to 82k. FIG. 7A illustrates the guide portion 97, i.e., 97k, that engages with the guided portion 82k of the tray 80k, and FIG. 7B illustrates the guide portion 97, i.e., 97m, that engages with the guided portion 82m of the tray 80m. The rotary body 90 includes similar guide portions that respectively engage with the guided portions 82y and 82c of the trays 80y and 80c. In addition, the guide portions 97 provided on one side, i.e., +Y side, of the rotary body 90 in the Y direction are illustrated in FIGS. 7A and 7B, but similar guide portions 97 are also provided on the other side, i.e., −Y side, of the rotary body 90 in the Y direction.

When the tray 80 moves between the accommodation position and the removal position, the guide portion 97 maintains the state being engaged with the guided portion 82 in at least a portion of the movement range, and guides the movement direction of the tray 80. In the present embodiment, the guide portion 97 maintains the state being engaged with the guided portion 82k in the entirety of the movement range of the tray 80k between the accommodation position and the removal position. In addition, in the present embodiment, the guide portion 97 maintains the state being engaged with the guided portion 82m in the entirety of the movement range of the tray 80m between the accommodation position and the removal position.

In addition, as illustrated in FIGS. 8 and 9, the four trays 80y to 80k are disposed in the rotary body 90 so as to overlap with each other as will be described in detail below.

When the pinion gears 94y to 94k rotate, the rack portions 83y to 83k and the trays 80y to 80k move with respect to the rotary body 90. As illustrated in FIG. 9, the four trays 80y to 80k are arranged such that the movement directions thereof with respect to the rotary body 90 are rotated by 90° from each other. Therefore, the tray 80y and the tray 80c, and similarly the tray 80m and the tray 80k, are respectively held so as to be slidable in approximately the same direction, i.e., parallel directions, to each other. The movement directions of movement in sliding motion of the trays 80y to 80k are regulated by the engagement between the guide portions 97 and the guided portions 82y to 82k described above.

The trays 80y to 80k move to the outside of the apparatus through the opening 16a. When the trays 80y to 80k each move to the outside of the apparatus through the opening 16a, the movement directions of the trays are approximately the same, i.e., parallel.

As illustrated in FIG. 9, regarding the movement direction Dk of the tray 80k, the range in which the tray 80k is disposed overlaps with the range in which the tray 80y is disposed and the range in which the tray 80c is disposed. In addition, regarding the movement direction Dk of the tray 80k, the range in which the tray 80k is disposed overlaps with the rotational axis 90C of the rotary body 90. That is, it can be said that the toner cartridge 70k held by the cartridge holding portion 81k of the tray 80k overlaps with the rotational axis 90C of the rotary body 90 illustrated in FIG. 4B.

Meanwhile, regarding the movement direction Dm of the tray 80m, the range in which the tray 80m is disposed is arranged in a displaced manner such that it does not overlap with the range in which the tray 80y is disposed and the range in which the tray 80c is disposed. Further, regarding a movement direction Dy of the tray 80y, the range in which the tray 80y is disposed is arranged in a displaced manner such that it does not overlap with the range in which the tray 80m is disposed and the range in which the tray 80k is disposed. Similarly, regarding a movement direction Dc of the tray 80c, the range in which the tray 80c is disposed is arranged in a displaced manner such that it does not overlap with the range in which the tray 80m is disposed and the range in which the tray 80k is disposed.

The positional relationship between the trays 80 may be also expressed as follows. As viewed in the movement direction Dy of the tray 80y, the tray 80y and the tray 80k overlap with each other, but the tray 80y and the tray 80m do not overlap with each other. As viewed in the movement direction Dm of the tray 80m, the tray 80m and the tray 80k overlap with each other, but the tray 80m and the trays 80y and 80c do not overlap with each other. As viewed in the movement direction Dc of the tray 80c, the tray 80c and the tray 80k overlap with each other, but the tray 80c and the tray 80m do not overlap with each other.

What is meant by two elements, such as members, components, and units, overlapping with each other as viewed in a specific direction is that a projected region of one element and a projected region of the other element at least partially overlap with each other in a case where the elements are projected perpendicularly onto a virtual plane perpendicular to the specific direction.

As illustrated in FIGS. 8 and 10, with respect to the direction of the rotational axis 90C, i.e., Y direction, a range in which the rack portion 83m and the guided portion 82m are disposed and a range in which the rack portion 83k and the guided portion 82k are disposed at least partially overlap with each other. That is, in the present embodiment, it can be said that with respect to the rotational axis direction of the rotary, i.e., Y direction, a range in which the first rack gear, i.e., rack portion 83k, is disposed and a range in which the second rack gear, i.e., rack portion 83m, is disposed at least partially overlap with each other. Therefore, as compared with an arrangement in which the rack portion 83m and the guided portion 82m do not overlap with the rack portion 83k and the guided portion 82k, the rack portions 83m and 83k and the guided portions 82m and 82k may be arranged in a smaller space in the Y direction.

With respect to the direction of the rotational axis 90C, i.e., Y direction, a range in which the rack portion 83y and the guided portion 82y are disposed and a range in which the rack portion 83c and the guided portion 82c are disposed at least partially overlap with each. That is, in the present embodiment, it can be said that with respect to the rotational axis direction of the rotary, i.e., Y direction, a range in which a third rack gear, i.e., rack portion 83y, is disposed and a range in which a fourth rack gear, i.e., rack portion 83c, is disposed at least partially overlap with each other. Therefore, as compared with an arrangement in which the rack portion 83y and the guided portion 82y do not overlap with the rack portion 83c and the guided portion 82c, the rack portions 83y and 83c and the guided portions 82y and 82c may be arranged in a smaller space in the Y direction.

Here, a meshing position between the rack portion, i.e., rack gear, 83 and the pinion gear 94 will be described with reference to FIG. 10. An upper half portion of FIG. 10 illustrates a meshing position between the rack portion 83k and the pinion gear 94k. A lower half portion of FIG. 10 illustrates a meshing position between the rack portion 83y and the pinion gear 94y.

In a region Y1 in the drawings in the direction of the rotational axis 90C of the rotary body 90, i.e., Y direction, the driving force transmitted from the motor M2 illustrated in FIG. 2 serving as a drive source to a transmission device that will be described below is transmitted to the pinion gears 94y to 94k. In a region Y2 in the drawings in the Y direction, the pinion gear 94k is meshed with the rack portion 83k in a manner capable of transmitting the driving force. In a region Y3 in the drawings in the Y direction, the pinion gear 94y is meshed with the rack portion 83y in a manner capable of transmitting the driving force. The rack portion 83m is meshed with the pinion gear 94m illustrated in FIG. 8 in the region Y2 similarly to the rack portion 83k in a manner capable of transmitting the driving force. The rack portion 83c is meshed with the pinion gear 94c illustrated in FIG. 8 in the region Y3 similarly to the rack portion 83y in a manner capable of transmitting the driving force.

Here, the regions Y2 and Y3 are at different positions in the Y direction, that is, are displaced from each other in the Y direction. In addition, the region Y1 is at a position different from both the regions Y2 and Y3 in the Y direction. That is, the region Y1 is displaced from the regions Y2 and Y3 in the Y direction.

Further, in a state where the toner cartridges 70y and 70c are at the attached position, with respect to a movement direction of the rack portion 83y, i.e., movement direction Dy of the tray 80y, a range in which the rack portion 83y is disposed and a range in which the rack portion 83c is disposed at least partially overlap with each other. In the present embodiment, since the movement directions Dy and Dc of the trays 80y and 80c are substantially the same, i.e., parallel, also with respect to the movement direction Dc of the tray 80c, a range in which the rack portion 83y is disposed and a range in which the rack portion 83c is disposed at least partially overlap with each other. Therefore, in a state where the toner cartridges 70y and 70c are at the attached position, the tooth surface of the rack portion 83y faces the tooth surface of the rack portion 83c in a direction, i.e., left-right direction of FIG. 8, orthogonal to the movement directions Dy and Dc of the rack portions 83y and 83c.

Further, in a state where the toner cartridges 70m and 70k are at the attached position, with respect to a movement direction of the rack portion 83m, i.e., movement direction Dm of the tray 80m, a range in which the rack portion 83m is disposed and a range in which the rack portion 83k is disposed at least partially overlap with each other. In the present embodiment, since the movement directions Dm and Dk of the trays 80m and 80k are substantially the same, i.e., parallel, also with respect to the movement direction Dk of the tray 80k, a range in which the rack portion 83m is disposed and a range in which the rack portion 83k is disposed at least partially overlap with each other. Therefore, in a state where the toner cartridges 70m and 70k are at the attached position, the tooth surface of the rack portion 83m faces the tooth surface of the rack portion 83k in a direction, i.e., up-down direction of FIG. 8, orthogonal to the movement directions Dm and Dk of the rack portions 83m and 83k.

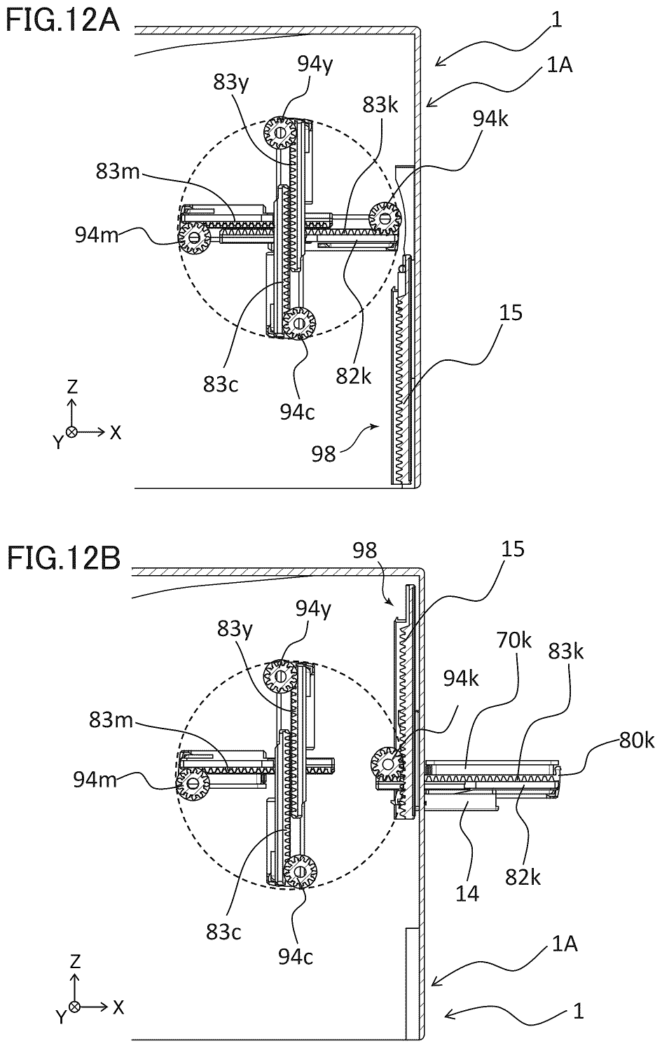

In addition, as illustrated in FIG. 12A described later, the rack portion 83y overlaps with the rack portions 83m and 83k as viewed in the direction of the rotational axis 90C, i.e., Y direction. As viewed in the direction of the rotational axis 90C, i.e., Y direction, the rack portion 83m overlaps with the rack portions 83y and 83c. As viewed in the direction of the rotational axis 90C, i.e., Y direction, the rack portions 83c overlap with the rack portions 83m and 83k. As viewed in the direction of the rotational axis 90C, i.e., Y direction, the rack portion 83k overlaps with the rack portions 83y and 83c. In other words, it can be said that with respect to the rotational axis direction of the rotary, i.e., Y direction, a range in which the first rack gear, i.e., rack portion 83k, is disposed does not overlap with a range in which the second rack gear, i.e., rack portion 83y, is disposed. In addition, it can be said that, as viewed in the rotational axis direction of the rotary, i.e., Y direction, in a state where the first toner cartridge 70k is at the first attached position and the second toner cartridge 70y is at the second attached position, the first rack gear, i.e., rack portion 83k, and the second rack gear, i.e., rack portion 83y, overlap with each other.

As described above, since the positions where the rack portions 83k and 83m are disposed and the positions where the rack portions 83y and 83c are disposed differ in the Y direction, the rack portions 83y and 83c may be arranged to overlap with the rack portions 83m and 83k as viewed in the Y direction.

As a result, the space for arranging the four trays in the rotary body 90 may be reduced, and the rotary body 90 may be downsized in the rotational radius direction. That is, when the rack portions 83 are to be arranged such that the movement distances of the trays 80y to 80k are equivalent to those of the present embodiment and the rack portions 83 do not overlap with each other as viewed in the Y direction, the area required for the arrangement of the four rack portions is widened when viewed in the Y direction. As compared with such a configuration, as a result of arranging the plurality of rack portions 83 in a displaced manner in the Y direction such that the rack portions 83 overlap with each other when viewed in the Y direction, the installation area for the rack portions 83 when viewed in the Y direction may be reduced.

In addition, in the present embodiment, two pairs of two of the four rack portions 83y to 83k are arranged in a displaced manner in the Y direction. That is, it can be said that with respect to in the rotational axis direction of the rotary, i.e., Y direction, the ranges in which the first rack gear and the second rack gear are disposed overlap with each other, and the ranges in which the third rack gear and the fourth rack gear are disposed overlap with each other. In addition, it can be said that with respect to the Y direction, the range in which the first rack gear and the second rack gear are disposed does not overlap with the range in which the third rack gear and the fourth rack gear are disposed. As a result, the size of the rotary body 90 in the Y direction may be reduced as compared with a case where all the four rack portions 83y to 83k are arranged in a displaced manner in the Y direction.

### Movement Configuration of Tray

Elements related to the movement of the trays 80y to 80k disposed in the rotary body 90 will be described with reference to FIGS. 11A, 11B, 12A, and 12B. FIGS. 11A and 11B are each a perspective view of elements related to the movement of the tray 80k. FIGS. 12A and 12B are each a cross-sectional view of elements related to the movement of the tray 80k.

In the present embodiment, the trays 80y to 80k are respectively driven by receiving the driving force of the motor M2 transmitted to the pinion gears 94y to 94k via the driving racks 15L and 15R serving as transmission devices. Here, the configuration for moving the tray 80k with respect to the rotary body 90 will be described, and the configurations for moving the trays 80y to 80c with respect to the rotary body 90 will not be described, since they are substantially the same as the configuration for moving the tray 80k.

FIG. 11A illustrates a state where the tray 80k is inside the rotary body 90, that is, in a state where the toner cartridge 70k is attached to the developing unit 50k. That is, FIG. 11A illustrates a state where the tray 80k is at the accommodation position, and corresponds to a state where the toner cartridge 70k is at the attached position with respect to the developing frame 53k illustrated in FIG. 4A. FIG. 11B illustrates a state where the tray 80k has been moved by sliding to the outside of the rotary body 90. That is, FIG. 11B illustrates a state where the tray 80k is at the attached position, and corresponds to a state where the toner cartridge 70k is at the retracted position with respect to the developing frame 53k illustrated in FIG. 4A.

The apparatus body 1A of the present embodiment includes the driving racks 15L and 15R serving as driving gears that drive the pinion gears 94. The driving racks 15 are each driven by the motor M2 via the transmission portion 15t. As illustrated in FIG. 11A, in a state where the tray 80k is inside the rotary body 90, that is, in a state where the toner cartridge 70k is attached to the developing unit 50k, the driving racks 15L and 15R are at a disengaged position separated from the pinion gear 94k. The driving racks 15L and 15R move from the disengaged position and engage with the pinion gears 94k such that the tray 80k moves from the accommodation position to the removal position and the toner cartridge 70k moves from the attached position to the retracted position.

As described above, two rack portions 83k are formed at respective end portions of the tray 80k in the Y direction. Two pinion gears 94k and the driving racks 15L and 15R are disposed at positions respectively corresponding to the rack portions 83k at the respective end portions. That is, the apparatus body 1A of the present embodiment includes the driving racks 15L and 15R serving as the first driving gear and the second driving gear. It can be said that the driving rack 15L is an example of a first driving gear, and the driving rack 15R is an example of a second driving gear.

This numbering is merely used for the sake of convenience of description, and can be interchanged arbitrarily in principle. In the case where there is no need to distinguish the driving racks 15L and 15R from each other, the driving racks will be each described as “the driving rack 15”.

The rack portions 83 of the present embodiment are configured as a pair of rack gears, and the pinion gears 94 of the present embodiment are configured as a pair of pinion gears. The pair of rack gears and the pair of pinion gears are disposed on the first end side and the second end side of the support member, i.e., tray 80, in the Y direction in the present embodiment, but they may be disposed at other positions. The rack portions 83k and the pinion gears 94k of the moving device 85k corresponding to the tray 80k can be respectively referred to as examples of a first pair of rack gears and a first pair of pinion gears.

The rack portions 83y to 83c and the pinion gears 94y to 94c of the moving devices 85y to 85c respectively corresponding to the other trays 80y to 80c can be respectively referred to as examples of second pairs of rack gears and second pairs of pinion gears.

One of the pair of rack gears meshes with one of the pair of pinion gears, and the other of the pair of rack gears meshes with the other of the pair of pinion gears. At least one of the pair of pinion gears is driven by the driving rack 15L serving as a first driving rack. In the present embodiment, two pairs of pinion gears are simultaneously driven by the driving racks 15L and 15R serving as the first driving rack and a second driving rack. As a result, rotation of the tray 80 is less likely to occur, and stable movement of the toner cartridge 70 is made possible. Alternatively, a configuration in which the tray 80 includes one rack portion 83 and is moved by one driving rack 15 via one pinion gear 94 may be employed.

The tray 80k is held to be slidable in a direction parallel to the guided portion 82k, that is, the movement direction Dk, with respect to the rotary body 90. The driving rack 15 is held to be slidable in a direction intersecting the movement direction Dk of the tray 80k with respect to the apparatus body 1A. The driving rack 15 is configured to slide, i.e., reciprocate, in a first movement direction, which is a vertically upward direction in the present embodiment, and a second movement direction, which is a vertically downward direction in the present embodiment, opposite to the first movement direction, with respect to the apparatus body 1A. That is, the movement direction of the driving rack 15 of the present embodiment is a direction intersecting, preferably orthogonal to, both the movement direction Dk of the tray 80k and the direction of the rotational axis 90C of the rotary body 90, i.e., Y direction.

A tray moving operation of sliding the tray 80k between the accommodation position and the detachment position will be described with reference to FIGS. 11A and 11B. The tray moving operation of the tray 80k is performed by the motor M2 illustrated in FIG. 2, the transmission portion 15t, the driving rack 15, the pinion gear 94k, and the rack portion 83k.

First, a tray moving operation, i.e., tray draw-out operation, of detaching the toner cartridge 70k from the rotary body 90 will be described. In a state before the tray draw-out operation is started, the driving rack 15 illustrated in FIG. 11A is positioned below a position where the driving rack 15 meshes with the pinion gear 94k. In addition, as described above, in the replacement operation of the toner cartridge 70k, the rotary body 90 takes the replacement posture illustrated in FIG. 4B for the toner cartridge 70k.

When the tray draw-out operation is started, the driving racks 15 are slid upward with respect to the apparatus body 1A by the driving force of the motor M2. In the course of movement of the driving racks 15, the driving racks 15 mesh with the pinion gears 94k, and the pinion gears 94k are rotationally driven.

As illustrated in FIG. 11B, the pinion gears 94k are rotationally driven in an arrow direction, and thus the driving force is entered to the rack portions 83k meshed with the pinion gears 94k. As a result, the tray 80k is pushed to the outside of the apparatus, and moves from the accommodation position to the detachment position with respect to the rotary body 90. The movement direction of the tray 80k in this movement is guided to the predetermined movement direction Dk by the engagement between the guided portion 82k and the guide portion 97k of the rotary body 90 illustrated in FIG. 7A. As a result of the tray 80k moving from the accommodation position to the detachment position, the toner cartridge 70k is moved from the attached position to the retracted position with respect to the developing unit 50k.

In a state where the tray 80k is positioned at the removal position and the toner cartridge 70k is positioned at the retracted position, the user may attach and detach the toner cartridge 70k to and from the tray 80k.

The tray moving operation, i.e., tray draw-in operation or tray insertion operation, at the time of attaching the toner cartridge 70 to the rotary body 90 is performed in a process reversed from the tray draw-out operation. For example, the tray draw-in operation is started in response to the user operating a predetermined operation portion. When the tray draw-in operation is started, the driving racks 15 are slid downward with respect to the apparatus body 1A by the driving force of the motor M2. Here, the rotational direction of the motor M2 in the tray draw-in operation is opposite to that in the tray draw-out operation.

As a result of the pinion gears 94k being rotationally driven in a direction opposite to the arrow of FIG. 11B, the driving force is entered to the rack portions 83k meshed with the pinion gears 94k. As a result, the tray 80k is drawn into the apparatus, and moves from the removal position to the accommodation position with respect to the rotary body 90.

The movement direction of the tray 80k is guided to the movement direction Dk opposite to the arrow of FIG. 11B by the engagement between the guided portion 82k and the guide portion 97k (FIG. 7A) of the rotary body 90. As a result of the tray 80k moving from the removal position to the accommodation position, the toner cartridge 70k is moved from the retracted position to the attached position with respect to the developing unit 50k.

Movement of the tray 80k and the toner cartridge 70k for black has been described above, and movement of the other trays 80y to 80c and toner cartridges 70y to 70c is also performed by a similar mechanism. That is, the driving racks 15 transmit drive to the pinion gears 94y to 94c in respective replacement postures of the toner cartridges.

The motor M2 provided in the apparatus body 1A and the transmission device including the driving racks 15, i.e., 15L and 15R, and the transmission portion 15t constitute the driving device 98 for driving the moving devices 85 provided in the rotary body 90.

As described above, in the present embodiment, a plurality of moving devices 85k to 85y corresponding to the plurality of toner cartridges 70k to 70y are disposed in the rotary body 90. The driving device 98 of the apparatus body 1A is a common driving device that drives the plurality of moving devices 85k to 85y, i.e., plurality of driven devices, of the rotary body 90.

In addition, in the present embodiment, the driving target of the driving device 98 switches in accordance with the rotation of the rotary body 90. In other words, the driving device of the present embodiment includes the driving racks 15 each serving as a transmission member that transmits the driving force of the drive source. The driving device can take a state where the transmission member engages with a first driven portion, e.g., pinion gear 94k, in a manner capable of transmitting the driving force and a state in which the transmission member engages with a second driven portion, e.g., pinion gear 94m, in a manner capable of transmitting the driving force. In addition, the driving device can take a state where the transmission member is disengaged from the first driven portion and the second driven portion.

As described above, the pinion gears 94y to 94k are held by the rotary body 90. Therefore, when the rotary body 90 rotates, it is preferable that the meshing between the driving racks 15 and the pinion gears 94y to 94k is released.

FIG. 12A illustrates a state where the tray 80k is inside the rotary body 90, that is, a state where the tray 80k is at the accommodation position. FIG. 12B illustrates a state where the tray 80k has moved to the outside of the rotary body 90, that is, a state where the tray 80k has moved to the removal position.

As illustrated in FIG. 12A, when the tray 80k is inside the rotary body 90, the driving racks 15 are positioned in a lower portion in the apparatus body 1A. At this time, the driving racks 15 are retracted from the pinion gears 94k. Therefore, the rotary body 90 may be rotated without being interrupted by the driving racks 15. More specifically, the driving racks 15 may be retracted to the outside of the rotational trajectory of the rotary body 90 indicated by dashed lines in FIGS. 12A and 12B.

As described above, by rotationally driving the motor M2 in normal and reverse directions, the tray 80 attached to the rotary body 90 may be moved from the accommodation position to the removal position and from the removal position to the accommodation position with respect to the rotary body 90. That is, the driving device of the present embodiment may drive the moving devices such that not only the toner cartridges move from the attached position to the retracted position but also the toner cartridges move from the retracted position to the attached position.

Here, as described above, in the present embodiment, the moving amount of the tray 80 during replacement of the toner cartridge is varied in accordance with the size of the toner cartridge 70. Specifically, the moving distance L1 of the movement of the black tray 80k from the accommodation position to the removal position is longer than the moving distance L2 of the movement of the other trays 80y to 80c from the accommodation position to the removal position as illustrated in FIGS. 7A and 7B.

Therefore, in the present embodiment, when moving the toner cartridges 70y to 70k from the attached position to the retracted position, a value obtained by dividing the speed of the rack portions 83k by the speed of the driving racks 15 is greater than a value obtained by dividing the speed of the rack portions 83y to 83c by the speed of the driving racks 15.

For example, as illustrated in FIG. 10, the pinion gear 94y is formed as a stepped gear, wherein a small-diameter gear 942 that meshes with the rack portion 83y has a smaller pitch radius than a pitch radius of a large-diameter gear 941 that meshes with the driving rack 15. The pinion gears 94m and 94c are formed as similar stepped gears. Meanwhile, the pinion gear 94k is formed such that a portion thereof that meshes with the driving rack 15 and a portion thereof that meshes with the rack portion 83k have the same pitch radius. In this case, the pitch radius of the pinion gear 94k can be equal to the pitch radius of the large-diameter gear 941 of the pinion gears 94y to 94c. According to this configuration, the moving distance of the rack portions 83k can be made greater than the moving distance of the other rack portions 83y to 83c even in the case where the moving distance of the driving racks 15 is the same. That is, the moving distance L1 of the movement of the black tray 80k from the accommodation position to the removal position may be made larger than the moving distance L2 of the movement of the other trays 80y to 80c from the accommodation position to the removal position.

In addition, by forming the pinion gears 94y to 94c as stepped gears, the moving distance L1 of the tray 80k can be made greater than the moving distance L2 of the other trays 80y to 80c even in the configuration in which the pinion gears 94y to 94k receive the driving force from the same driving racks 15.

The pinion gear 94k may be formed as a stepped gear instead of, or in combination with, the configuration in which the pinion gears 94y to 94c are formed as stepped gears. In this case, a portion of the pinion gear 94k that meshes with the driving rack 15 may be formed as a small-diameter gear, and a portion of the pinion gear 94k that meshes with the rack portion 83k may be formed as a large-diameter gear having a greater pitch radius than the small-diameter gear. In addition, the stepped gear is an example of a speed reduction mechanism, and may be replaced by a known speed reduction mechanism that makes the moving amount of a member on the input side, i.e., drive source side, smaller than a moving amount of a member on the output side, i.e., tray 80 side.

In addition, the moving amount of the driving rack 15 when the toner cartridge 70k moves from the attached position to the retracted position may be made greater than the moving amount of the driving rack 15 when the toner cartridges 70y to 70c move from the attached position to the retracted position.

Incidentally, in the case where the distance of movement of the toner cartridge 70 from the attached position to the retracted position is shorter, the movement time of the toner cartridge 70 can be made shorter, and the time during which the user waits for the toner cartridge 70 to move can be made shorter. If a configuration in which the moving amount of the driving racks 15 for the toner cartridge 70k is greater than the movement amount of the driving racks 15 for the toner cartridges 70y to 70c is employed as described above, the time during which the user waits for the toner cartridges 70y to 70c to move can be made shorter.

According to the configurations described above, the moving distance L1 may be made larger than the moving distance L2. These configurations may be employed in combination.

In the configuration described above, a configuration in which the driven portion includes the pinion gears 94 that mesh with both the driving racks 15 and the rack portions 83 has been described, but the configuration may also be configured such that the driven portion includes gears that mesh with the driving racks 15 and gears that mesh with the rack portions 83.

Further, the configuration of the moving device 85 that moves the tray 80 is not limited to a so-called rack-and-pinion configuration. For example, the member corresponding to the pinion gear 94 may be replaced with a roller that rotates by receiving drive from the motor M2, and the tray 80 may be moved by friction between the roller and the tray 80.

In a case where a roller that rotates by receiving the drive from the motor M2 is used, the roller may be brought into contact with the toner cartridge 70. In this case, the toner cartridges 70y to 70k may be made directly attachable to and detachable from the rotary body 90 without adopting the trays 80y to 80k. In this case, the moving device 85 is constituted by a roller.

### Right-Left Connection Configuration of Tray Drive Mechanism

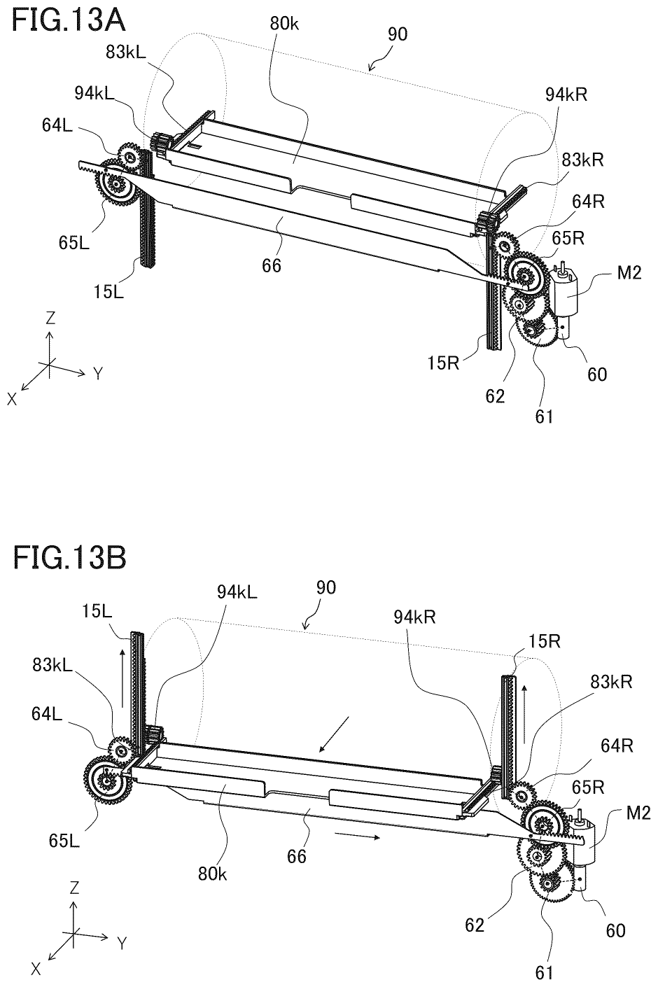

With reference to FIGS. 13A and 13B, a drive mechanism for moving the tray 80 arranged in the rotary body 90 will be described. The drive mechanism for moving the tray 80k with respect to the rotary body 90 will be described here, and the drive mechanism for moving the trays 80y to 80c are similar thereto, such that the description thereof will be omitted.

FIGS. 13A and 13B are each a perspective view illustrating the drive mechanism of the tray 80. FIG. 13A illustrates a state where the tray 80k is arranged inside the rotary body 90, i.e., in an accommodation position. FIG. 13B illustrates a state where the tray 80k has moved to the outside of the rotary body 90, i.e., in a removal position. As illustrated in FIGS. 13A and 13B, the drive mechanism of the tray 80k is composed of the motor M2, a worm gear 60, stepped gears 61 and 62, drive rack input gears 64L and 64R, stepped gears 65L and 65R, and a right-left connection rack 66.

The operation of a drive mechanism for moving the tray 80k from the accommodation position of FIG. 13A to the removal position of FIG. 13B will be described. In a state where the motor M2 is driven to rotate, driving force is transmitted via the worm gear 60, the stepped gear 61, the stepped gear 62, the stepped gear 65R, and the drive rack input gear 64R in the named order. By the drive rack input gear 64R having received driving force transmitted from the stepped gear 65R, the driving rack 15R slides in the upper direction of the apparatus body 1A, i.e., +Z direction. For sake of convenience of description, when the apparatus body 1A is viewed from the +X direction, that is, when viewed from the front side, the +Y direction side is referred to as a right side, and the −Y direction side is referred to as a left side.

Further, the right-left connection rack 66 is slid in the right direction of the apparatus body 1A, i.e., +Y direction, by the stepped gear 65R. Driving force is transmitted via the stepped gear 65L and the drive rack input gear 64L in the named order by the right-left connection rack 66 being slid in the +Y direction, and the driving rack 15L is slid in the upper direction of the apparatus body 1A, i.e., +Z direction, by the drive rack input gear 64L.

In the process of moving in the upper direction of the apparatus body 1A, the driving racks 15L and 15R respectively mesh with pinion gears 94kL and 94kR, and the pinion gears 94kL and 94kR are driven to rotate. Driving force is transmitted respectively from the pinion gears 94kL and 94kR to rack portions 83kL and 83kR of the tray 80k, and the tray 80k is moved toward the removal position on the outside of the rotary body 90.

### Lock Mechanism of Rotary Body

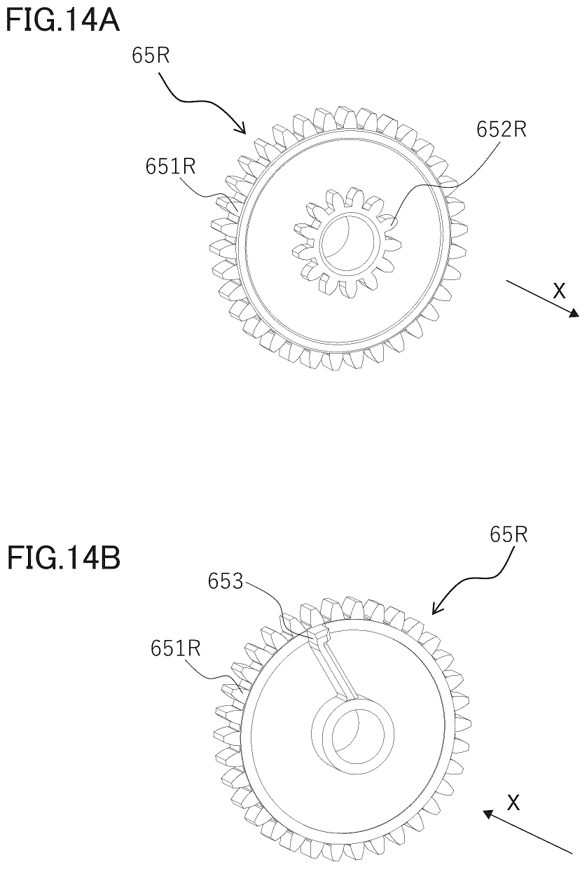

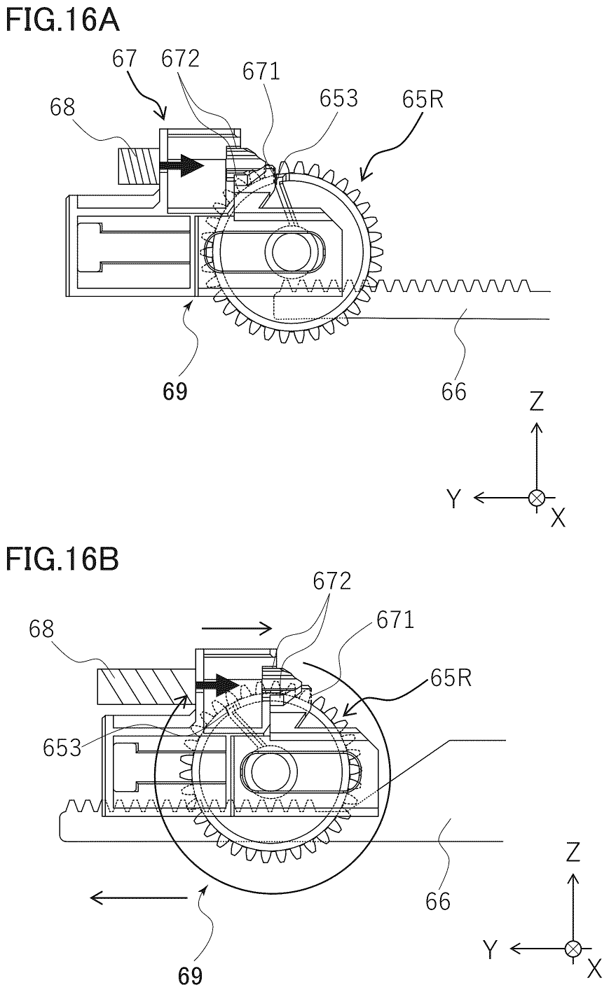

Next, a lock mechanism 69 (refer to FIG. 16A) of the rotary body 90 will be described with reference to FIGS. 14A to 17B. The lock mechanism 69 restricts the rotary body 90 from rotating about the rotational axis 90C when the rotary body 90 takes the replacement posture.

In the present embodiment, in order to have the pinion gear 94 mesh with the driving rack 15 described above when the tray 80 is moved from the accommodation position to the removal position, it is preferable that the pinion gear 94 is accurately positioned at the meshing position with the driving rack 15.

One cause of the pinion gear 94 being deviated from the meshing position is the dispersion of position of the rotary body 90 in the yellow/magenta/cyan/black replacement posture. When the pinion gear 94 is meshed with the driving rack 15, the tooth surface of the pinion gear 94 receives force from the tooth surface of the driving rack 15. If this force causes the rotary body 90 to rotate about the rotational axis 90C, the pinion gear 94 may be moved from the meshing position. Further, in a state where the tray 80 is at the removal position, if the user accidentally touches the rotary body 90 and causes the rotary body 90 to rotate, the pinion gear 94 may be moved from the meshing position.

Therefore, in the present embodiment, the lock mechanism 69 that locks the rotary body 90 in a rotation direction in the replacement posture is disposed. As described below, the lock mechanism 69 operates in the process during which the tray 80 moves from the accommodation position to the removal position, and locks the rotary body 90.

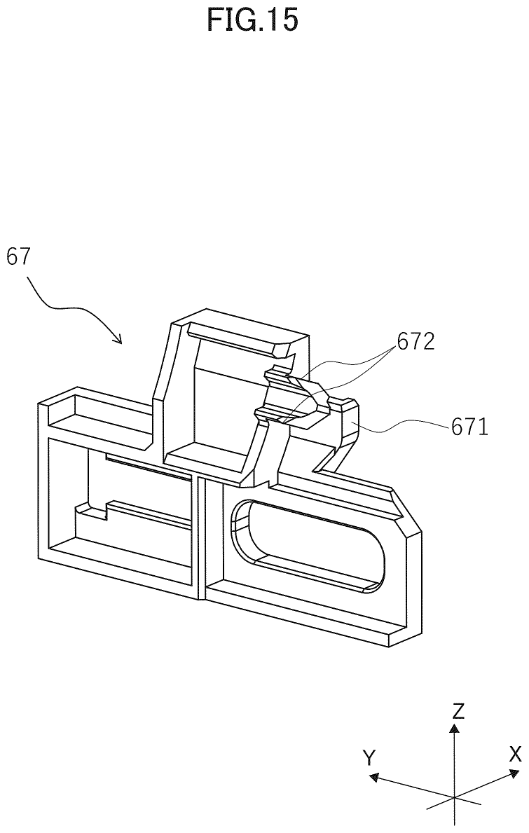

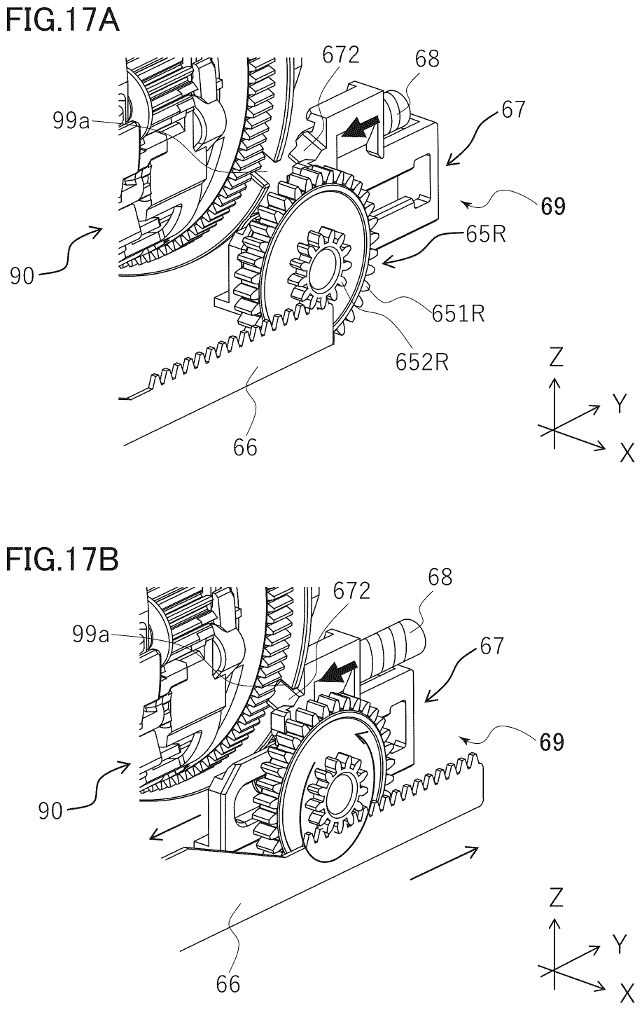

FIGS. 14A and 14B are each a perspective view of the stepped gear 65R. FIG. 15 is a perspective view of a locking member 67. FIGS. 16A and 16B are each a front view illustrating the operation of the lock mechanism 69. FIGS. 17A and 17B are each a perspective view illustrating the operation of the lock mechanism 69. As illustrated in FIGS. 14A and 14B, the stepped gear 65R includes a large-diameter gear 651R, a small-diameter gear 652R that rotates integrally with the large-diameter gear 651R and having a smaller number of teeth than the large-diameter gear 651R, and a pressing portion 653 formed integrally with the large-diameter gear 651R. The pressing portion 653 constitutes a portion of the lock mechanism 69 described below.

The locking member 67 illustrated in FIG. 15 also constitutes a portion of the lock mechanism 69 (refer to FIG. 16A). The locking member 67 is supported movably in the Y direction with respect to the apparatus body 1A, and includes a pressed portion 671 and an engagement portion 672. The pressed portion 671 is configured to be able to abut against the pressing portion 653 of the locking member 67.

Next, the operation of the lock mechanism 69 will be described with reference to FIGS. 16A to 17B. FIGS. 16A and 17A illustrate an unlocked state in which the lock mechanism 69 does not lock the rotary body 90, and FIGS. 16B and 17B illustrate a locked state in which the lock mechanism 69 locks the rotary body 90. As illustrated in FIGS. 16A and 17A, the lock mechanism 69 includes the pressing portion 653 of the stepped gear 65R, the locking member 67, and an urging member 68. The urging member 68 is disposed in the apparatus body 1A and urges the locking member 67 in the −Y direction.

In a state where the tray 80 is positioned at the accommodation position, the lock mechanism 69 is in the unlocked state, and the rotary body 90 is not locked by the lock mechanism 69. That is, the rotary body 90 is in a state rotatable about the rotational axis 90C. The rotary body 90 is provided with four engaged portions 99a to which the engagement portion 672 of the locking member 67 may engage. The engagement portion 672 of the locking member 67 may be engaged with one of the above-mentioned four engaged portions 99a when the rotary body 90 takes one posture among the yellow/magenta/cyan/black replacement postures. By having the engagement portion 672 engage with the engaged portion 99a, the rotation of the rotary body 90 about the rotational axis 90C is regulated.

In a state where the rotary body 90 is in one of the yellow/magenta/cyan/black replacement postures and the tray 80 is at the accommodation position, the pressing portion 653 of the stepped gear 65R comes into contact with the pressed portion 671 of the locking member 67. Thus, the urging member 68 restricts the movement of the locking member 67 urged in the −Y direction. In this state, as illustrated in FIG. 17A, the engagement portion 672 of the locking member 67 is separated from the engaged portions 99a of the rotary body 90, and does not lock the rotary body 90.

The stepped gear 65R having the pressing portion 653 disposed thereto constitutes a portion of the transmission portion 15t that transmits the drive from the motor M2 to the driving rack 15 during the tray moving operation. That is, the stepped gear 65R rotates while the tray moving operation is performed in which the tray 80 is slid between the accommodation position and the removal position. In the present embodiment, when the motor M2 is driven to move the tray 80 from the accommodation position to the removal position, the stepped gear 65R rotates in the clockwise direction of FIG. 16B.

Then, the pressing portion 653 of the stepped gear 65R also rotates in the clockwise direction, and moves in the −Y direction. Along therewith, the locking member 67 slides in the −Y direction by the urging force of the urging member 68. Then, as illustrated in FIG. 17B, the engagement portion 672 of the locking member 67 engages with the engaged portion 99a of the rotary body 90, and locks the rotary body 90. The driving rack 15 and the pinion gear 94 are engaged after the engagement portion 672 and the engaged portions 99a are engaged. Then, even in a state where the driving rack 15 and the pinion gear 94 are engaged and the tray 80 is positioned at the removal position, the rotary body 90 is locked by the lock mechanism 69.

A configuration is adopted in which the engagement of the engagement portion 672 and the engaged portion 99a is released after the engagement of the driving rack 15 and the pinion gear 94 is released in a state where the tray 80 is moved from the removal position to the accommodation position. Thus, the driving rack 15 and the pinion gear 94 are meshed with each other in a state where the rotation of the rotary body 90 is limited.

As described, in a state where the tray 80 is at the removal position by the lock mechanism 69 of the rotary body 90, the rotary body 90 is locked at the replacement posture. Therefore, it may be possible to suppress the occurrence of meshing failures between the pinion gear 94 and the driving rack 15 during the tray moving operation.

### Drive Transmission Configuration of Rotary Body and Conveyance Unit

As described with reference to FIG. 2, the apparatus body 1A includes the motors M1, M2, and M3, and the members driven by each of the motors M1, M2, and M3 may be set arbitrarily. The following description illustrates a configuration where the motor M1 serves as a drive source of both the rotary body 90 and a conveyance unit 350. The conveyance unit 350 includes the conveyance roller pair 320, and the conveyance roller pair 320 includes a conveyance roller 321 serving as a conveyance portion, and a driven roller 322 that is driven to rotate following the rotation of the conveyance roller 321.

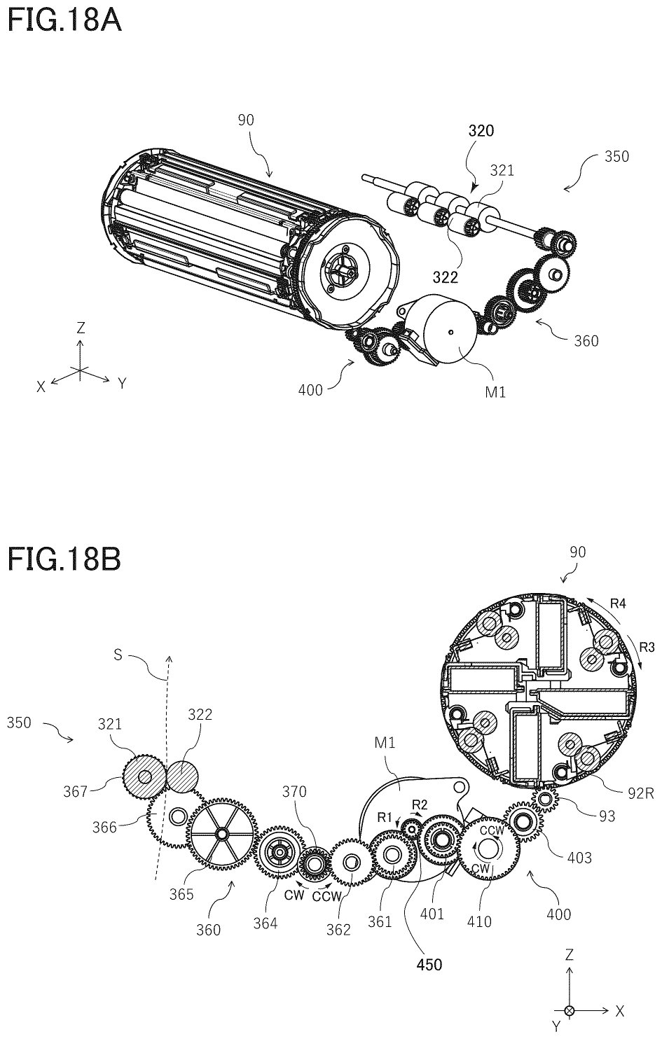

FIGS. 18A and 18B are each a view illustrating a drive transmission configuration from the motor M1 to the rotary body 90 and the conveyance unit 350. As illustrated in FIGS. 18A and 18B, the apparatus body 1A includes a rotational driving train 400 serving as a first drive transmission portion capable of transmitting drive from the motor M1 to the rotary body 90 serving as a first output portion. Further, the apparatus body 1A includes a conveyance roller drive train 360 serving as a second drive transmission portion capable of transmitting drive from the motor M1 to the conveyance roller 321 serving as a second output portion of the conveyance unit 350.

FIG. 18B is a cross-sectional view illustrating the rotary body 90, the conveyance roller 321, the rotational driving train 400, and the conveyance roller drive train 360 when viewing the frame 16 from the left side. As illustrated in FIG. 18B, the driving force output from the motor M1 is transmitted via a pinion gear 450 fixed to an output shaft of the motor M1 to the rotational driving train 400 and the conveyance roller drive train 360. The rotational driving train 400 includes a rotary driving stepped gear 401, a rotary driving ratchet gear, i.e., first switching portion, 410, a rotary driving idler gear 403, and a rotary driving gear 93. By having drive entered from the rotary driving gear 93 to a disk gear 92R of the rotary body 90, the rotary body 90 rotates.

Meanwhile, the conveyance roller drive train 360 includes conveyance driving stepped gears 361 and 365, conveyance driving idler gears 362, 364, and 366, a conveyance driving ratchet gear, i.e., second switching portion, 370, and a conveyance roller gear 367. By having drive entered from the conveyance roller gear 367 to the conveyance roller 321, the conveyance roller 321 rotates. For example, the conveyance roller gear 367 is fixed to a roller shaft to which the conveyance roller 321 is fixed. When the conveyance roller 321 rotates, the driven roller 322 rotates following the rotation of the conveyance roller 321. Thereby, the sheet S nipped by the conveyance roller 321 and the driven roller 322 is conveyed downstream in the conveyance direction.

### Rotary Driving Ratchet Gear

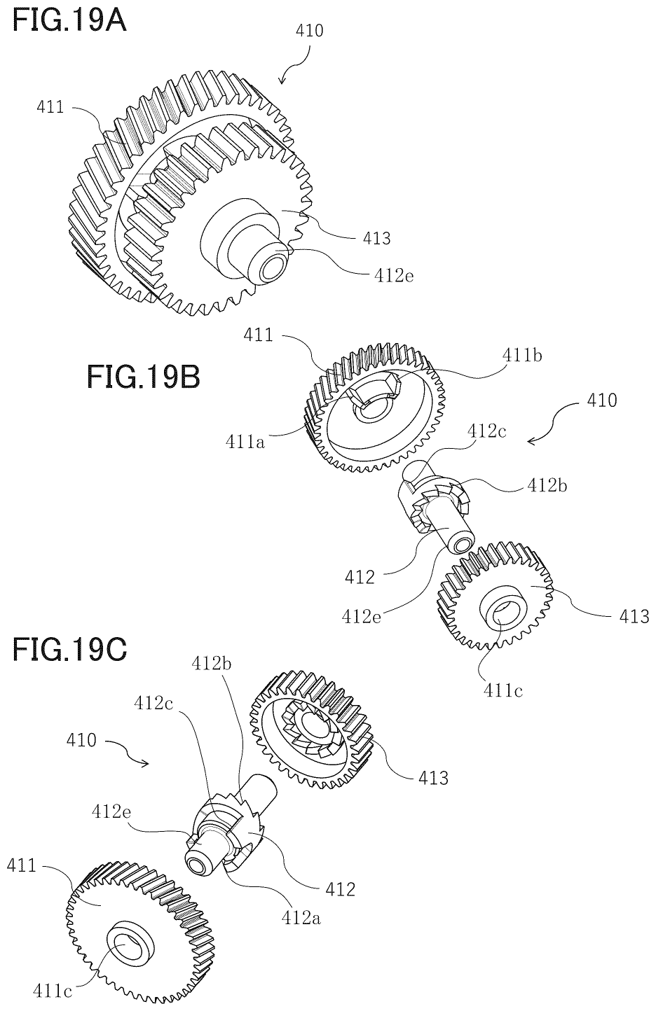

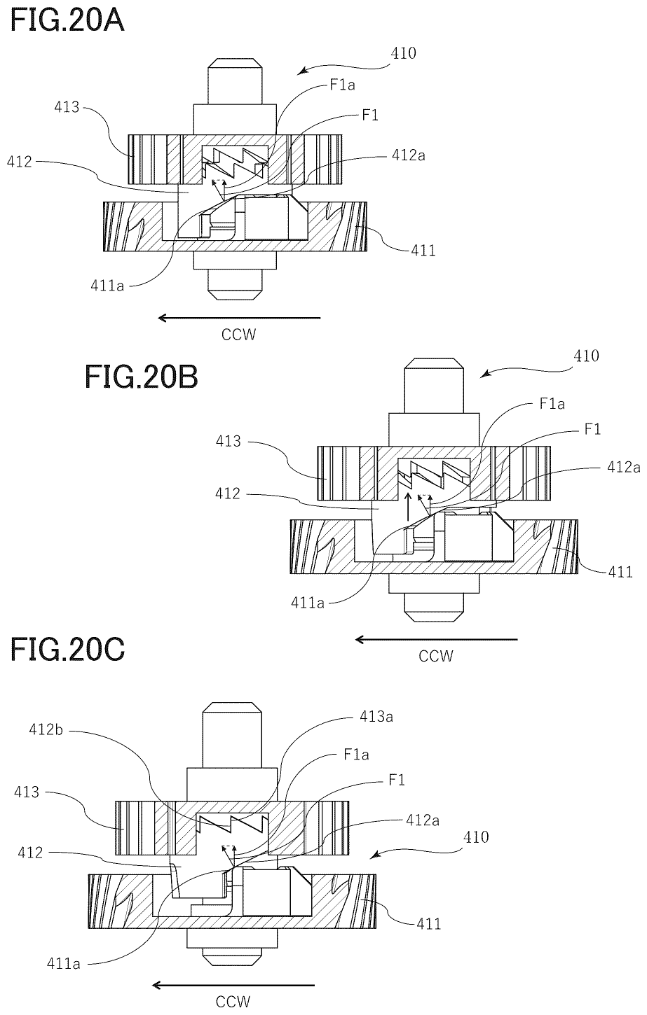

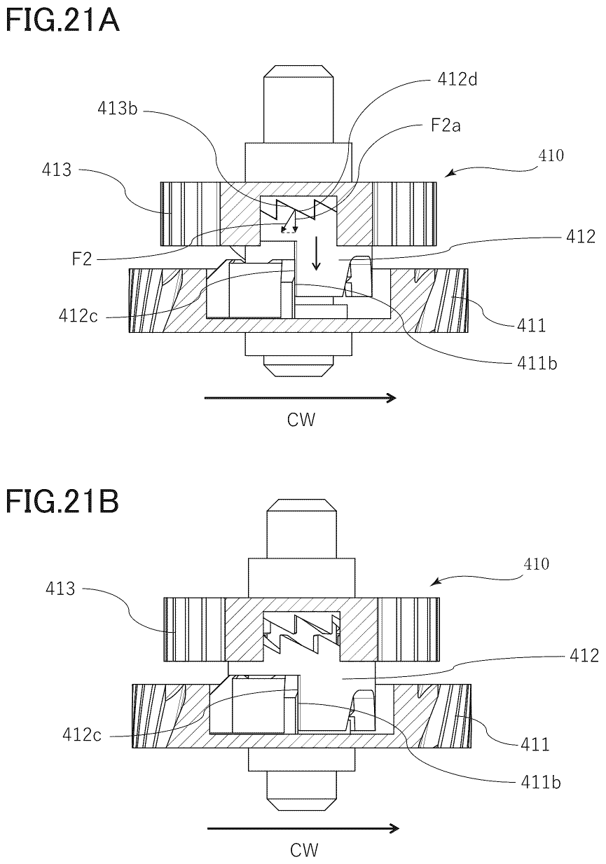

Next, a configuration of a rotary driving ratchet gear 410 will be described with reference to FIGS. 19A to 21B. FIGS. 19A to 19C are each a perspective view of the rotary driving ratchet gear 410. FIGS. 20A to 20C are each a view of an engagement operation of the rotary driving ratchet gear 410. FIGS. 21A and 21B are each a separating operation of the rotary driving ratchet gear 410.

As illustrated in FIGS. 19A to 19C, the rotary driving ratchet gear 410 includes an input portion 411, a slide engagement portion 412, and an output portion 413. The output portion 413 is meshed with the rotary driving idler gear 403. In a state where the driving force of the motor M1 is transmitted from the input portion 411 to the output portion 413, the driving force of the motor M1 is transmitted via the rotary driving idler gear 403 and the rotary driving gear 93 to the rotary body 90. When the input portion 411 rotates in a CCW direction, i.e., counterclockwise direction of FIG. 18B, the slide engagement portion 412 engages with the output portion 413, such that the rotary driving ratchet gear 410 serving as a first ratchet or ratchet will be in a first transmission state in which the drive from the motor M1 is transmitted to the rotary body 90. That is, the rotary driving ratchet gear 410 will be in the first transmission state when the motor M1 rotates in a first direction R1 so as to rotate the input portion 411 in the CCW direction. The rotation direction of the motor M1 is the same as the rotation direction of the pinion gear 450 fixed to the output shaft of the motor M1.

When the input portion 411 rotates in a CW direction, i.e., clockwise direction of FIG. 18B, the slide engagement portion 412 is not engaged with the output portion 413, such that the rotary driving ratchet gear 410 will be in a first non-transmission state in which the drive from the motor M1 is not transmitted to the rotary body 90. That is, the rotary driving ratchet gear 410 will be in the first non-transmission state when the motor M1 rotates in a second direction R2 opposite to the first direction R1 so as to rotate the input portion 411 in the CW direction.

As illustrated in FIGS. 19A and 19B, the input portion 411 includes pressing surfaces 411a and 411b and a hole portion 411c, wherein the pressing surfaces 411a and 411b are arranged at varied positions in the rotation direction of the input portion 411. A shaft 412e of the slide engagement portion 412 is passed through the hole portion 411c. As illustrated in FIGS. 19B and 19C, the slide engagement portion 412 serving as a second rotation member includes a pressed surface 412a being pressed by the pressing surface 411a of the input portion 411, a gear engagement surface 412b, and a pressed surface 412c being pressed by the pressing surface 411b of the input portion 411. The output portion 413 serving as a first rotation member includes a gear engagement surface 413a engageable with the gear engagement surface 412b of the slide engagement portion 412. The slide engagement portion 412 and the output portion 413 each have saw-tooth shaped teeth that face each other, and among these teeth, the portions capable of transmitting driving force by being engaged with each other are the gear engagement surfaces 412b and 413a. Further, gear slopes 412d (refer to FIG. 21A) that extend in a slanted manner with respect to the circumferential direction of the rotary driving ratchet gear 410 are formed on the teeth of the slide engagement portion 412. Similarly, gear slopes 413b (refer to FIG. 21A) that extend in a slanted manner with respect to the circumferential direction of the rotary driving ratchet gear 410 are formed on the teeth of the output portion 413.

FIG. 20A illustrates a state prior to starting an engagement operation of the rotary driving ratchet gear 410, that is, before the motor M1 rotates in the first direction R1. In this state, the slide engagement portion 412 is positioned at a disengaged position where it does not rotate integrally with the output portion 413. As described above, when the motor M1 rotates in the first direction R1, the input portion 411 rotates in the CCW direction. When the motor M1 rotates in the first direction R1, as illustrated in FIG. 20A, the pressing surface 411a of the input portion 411 comes into contact with the pressed surface 412a of the slide engagement portion 412, and a force F1 is transmitted from the input portion 411 to the slide engagement portion 412. By a component Fla of the force F1, the slide engagement portion 412 moves in a direction approaching the output portion 413, as illustrated in FIG. 20B.

When the movement of the slide engagement portion 412 is completed, as illustrated in FIG. 20C, the gear engagement surface 412b of the slide engagement portion 412 and the gear engagement surface 413a of the output portion 413 are engaged with each other, and the rotation of the input portion 411 is transmitted via the slide engagement portion 412 to the output portion 413. In this state, the slide engagement portion 412 is positioned at an engagement position where it is engaged to rotate integrally with the input portion 411 and the output portion 413.

Next, with reference to FIGS. 21A and 21B, a separating operation of the rotary driving ratchet gear 410 will be described. FIG. 21A illustrates a state prior to starting the separating operation of the rotary driving ratchet gear 410, that is, before the motor M1 rotates in the second direction R2. As described above, when the motor M1 rotates in the second direction R2, the input portion 411 rotates in the CW direction. When the motor M1 rotates in the second direction R2, as illustrated in FIG. 21A, the pressing surface 411b of the input portion 411 comes into contact with the pressed surface 412c of the slide engagement portion 412. Thereafter, the gear slopes 412d of the slide engagement portion 412 comes into contact with the gear slopes 413b of the output portion 413, and the slide engagement portion 412 receives a force F2 from the output portion 413.

By receiving a component F2a of the force F2, the slide engagement portion 412 moves in a direction separating from the output portion 413, as illustrated in FIG. 21B. That is, by the gear slopes 412d sliding on the gear slopes 413b of the output portion 413, the slide engagement portion 412 moves to a position where rotation is not transmitted to the output portion 413. In this state, the rotary body 90 arranged downstream in a drive transmission direction of the output portion 413 acts as a load when rotating the output portion 413, such that the output portion 413 is stopped.

### Conveyance Driving Ratchet Gear

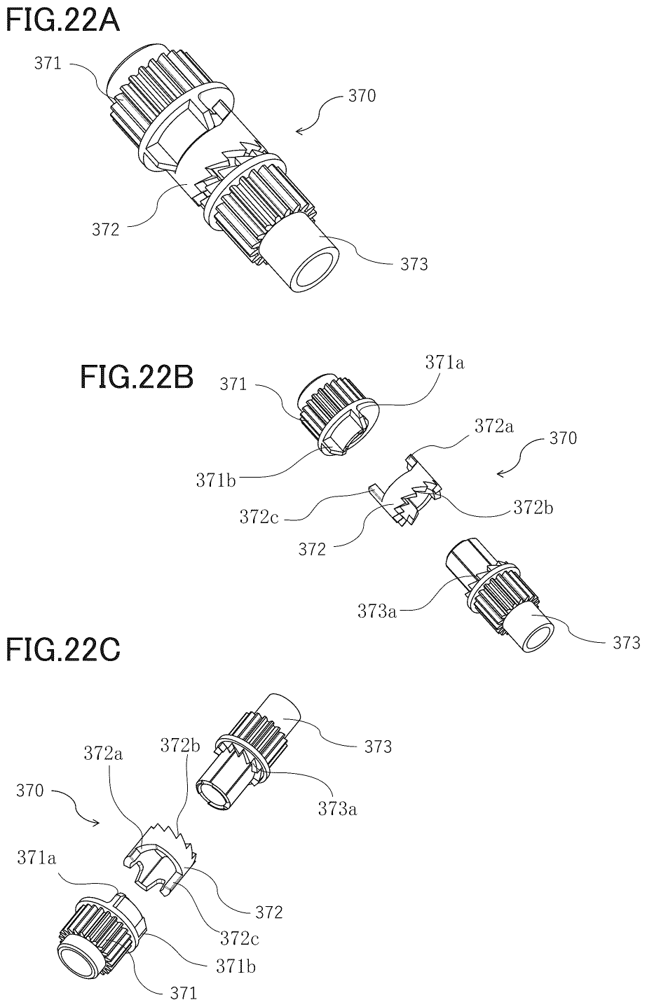

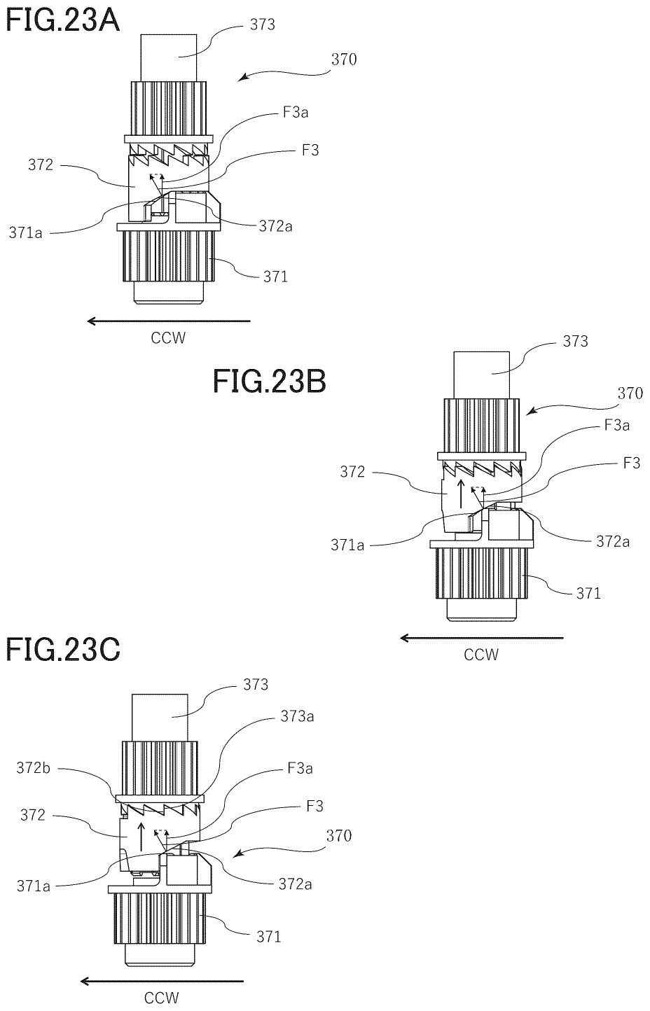

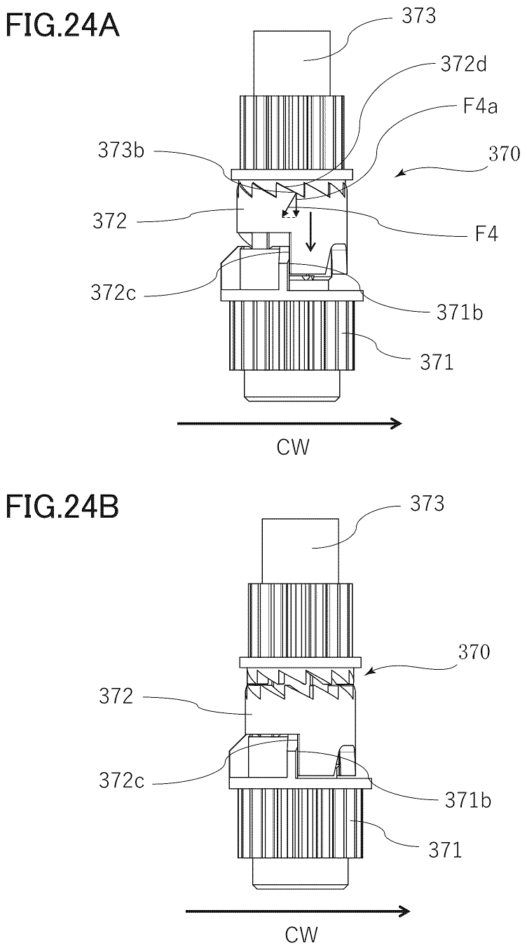

Next, a configuration of a conveyance driving ratchet gear 370 will be described with reference to FIGS. 22A to 24B. FIGS. 22A to 22C are each a perspective view of the conveyance driving ratchet gear 370. FIGS. 23A to 23C are each a view illustrating an engagement operation of the conveyance driving ratchet gear 370. FIGS. 24A and 24B are each a view illustrating a separating operation of the conveyance driving ratchet gear 370.

As illustrated in FIGS. 22A to 22C, the conveyance driving ratchet gear 370 serving as a second ratchet includes an input portion 371, a slide engagement portion 372, and an output portion 373. When a driving force of the motor M1 is transmitted via the input portion 371 to the output portion 373, the driving force of the motor M1 is transmitted to the conveyance roller 321. When the input portion 371 rotates in the CCW direction, i.e., counterclockwise direction, of FIG. 18B, the conveyance driving ratchet gear 370 will be in a second transmission state in which the slide engagement portion 372 and the output portion 373 are engaged and the drive from the motor M1 is transmitted toward the conveyance roller 321 of the conveyance unit 350. That is, the conveyance driving ratchet gear 370 will be in the second transmission state where the motor M1 is rotated in the second direction R2 such that the input portion 371 rotates in the CCW direction.

Further, when the input portion 371 rotates in the CW direction, i.e., clockwise direction, of FIG. 18B, the conveyance driving ratchet gear 370 will be in a second non-transmission state where the slide engagement portion 372 and the output portion 373 are not engaged and the drive from the motor M1 is not transmitted toward the conveyance roller 321. That is, the conveyance driving ratchet gear 370 will be in the second non-transmission state when the motor M1 is rotated in the first direction R1 such that the input portion 371 rotates in the CW direction.

As illustrated in FIG. 22B, the input portion 371 includes the pressing surfaces 371a and 371b, and the pressing surfaces 371a and 371b are arranged at different positions in the rotation direction of the input portion 371. As illustrated in FIGS. 22B and 22C, the slide engagement portion 372 includes a pressed surface 372a pressed by a pressing surface 371a of the input portion 371, a gear engagement surface 372b, and a pressed surface 372c pressed by a pressing surface 371b of the input portion 371. The output portion 373 includes a gear engagement surface 373a that is engageable with the gear engagement surface 372b of the slide engagement portion 372. The slide engagement portion 372 and the output portion 373 each have saw-tooth shaped teeth that face each other, and among these teeth, the portions capable of transmitting driving force by being engaged with each other are the gear engagement surfaces 372b and 373a. Further, gear slopes 372d (refer to FIG. 24A) that extend in a slanted manner with respect to the circumferential direction of the conveyance driving ratchet gear 370 are formed on the teeth of the slide engagement portion 372. Similarly, gear slopes 373b (refer to FIG. 24A) that extend in a slanted manner with respect to the circumferential direction of the conveyance driving ratchet gear 370 are formed on the teeth of the output portion 373.

FIG. 23A illustrates a state prior to starting an engagement operation of the conveyance driving ratchet gear 370, that is, before the motor M1 rotates in the second direction R2. As described above, when the motor M1 rotates in the second direction R2, the input portion 371 rotates in the CCW direction. When the motor M1 rotates in the second direction R2, as illustrated in FIG. 23A, the pressing surface 371a of the input portion 371 comes into contact with the pressed surface 372a of the slide engagement portion 372, and a force F3 is transmitted from the input portion 371 to the slide engagement portion 372. By receiving a component F3a of the force F3, the slide engagement portion 372 moves in a direction approaching the output portion 373, as illustrated in FIG. 23B.

When the movement of the slide engagement portion 372 is completed, as illustrated in FIG. 23C, the gear engagement surface 372b of the slide engagement portion 372 and the gear engagement surface 373a of the output portion 373 are engaged with each other, and the rotation of the input portion 371 is transmitted via the slide engagement portion 372 to the output portion 373. In this state, the slide engagement portion 372 rotates integrally with the input portion 371 and the output portion 373.

Next, with reference to FIGS. 24A and 24B, a separating operation of the conveyance driving ratchet gear 370 will be described. FIG. 24A illustrates a state prior to starting the separating operation of the conveyance driving ratchet gear 370, that is, before the motor M1 rotates in the first direction R1. As described above, when the motor M1 rotates in the first direction R1, the input portion 371 rotates in the CW direction. When the motor M1 rotates in the first direction R1, as illustrated in FIG. 24A, the pressing surface 371b of the input portion 371 comes into contact with the pressed surface 372c of the slide engagement portion 372. Thereafter, the gear slopes 372d of the slide engagement portion 372 come into contact with the gear slopes 373b of the output portion 373, and the slide engagement portion 372 receives a force F4 from the output portion 373.

By receiving a component F4a of the force F4, the slide engagement portion 372 moves in a direction separating from the output portion 373, as illustrated in FIG. 24B. That is, by the gear slopes 372d sliding on the gear slopes 373b of the output portion 373, the slide engagement portion 372 moves to a position where rotation is not transmitted to the output portion 373. In this state, the conveyance roller 321 arranged downstream in a drive transmission direction of the output portion 373 acts as a load when rotating the output portion 373, such that the output portion 373 is stopped.

As described above, in a state where the motor M1 rotates in the first direction R1, the rotary driving ratchet gear 410 is in the first transmission state, such that the rotary body 90 rotates about the rotational axis 90C, and the conveyance driving ratchet gear 370 is in the second non-transmission state, such that the conveyance roller 321 does not rotate. Meanwhile, in a state where the motor M1 rotates in the second direction R2, the rotary driving ratchet gear 410 is in the first non-transmission state, such that the rotary body 90 does not rotate, and the conveyance driving ratchet gear 370 is in the second transmission state, such that the conveyance roller 321 rotates. In a state where a restricting lever 430 described below is positioned at a restricting position, the operation of the rotary body 90 in a state where the motor M1 rotates in the second direction R2 differs from the operation described above. Reverse Rotation Configuration of Rotary Body

According to the drive transmission configuration of the rotary body 90 described above, the rotary body 90 rotates in a third direction R3, i.e., clockwise direction, when the motor M1 rotates in the first direction R1, but in a state where the motor M1 rotates in the second direction R2, the rotary body 90 does not rotate. However, in some cases, it is preferable for the rotary body 90 to be rotatable in both clockwise and counterclockwise directions. One example of such cases is when reading memory tags 72y to 72k attached to the toner cartridges 70y to 70k.

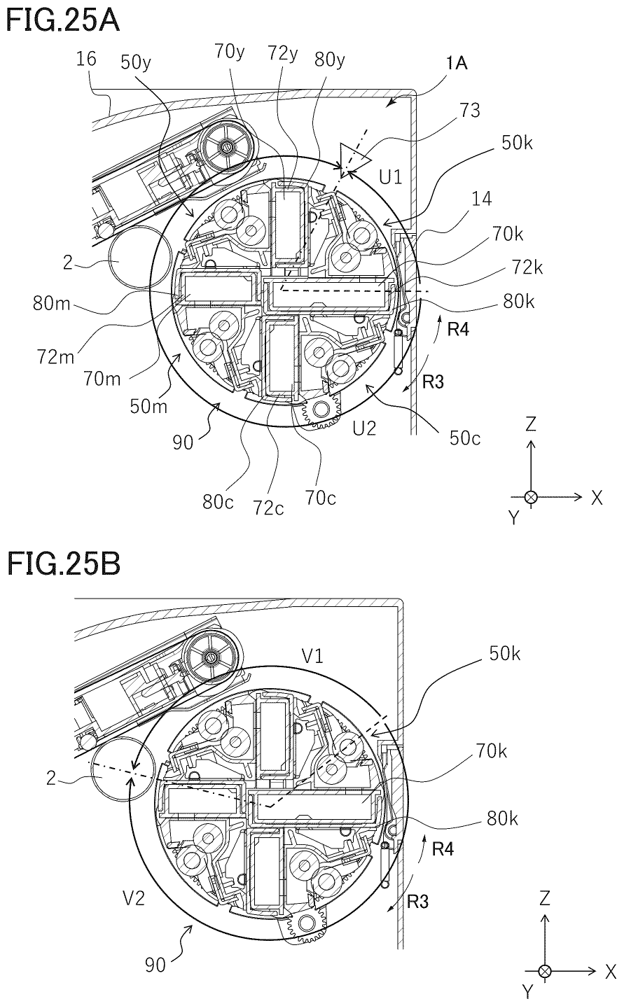

FIG. 25A is a cross-sectional view of the memory tags 72y to 72k. As illustrated in FIG. 25A, for example, a memory tag reading unit 73 disposed on the apparatus body 1A is positioned on an upper right of the rotary body 90. An example is considered of a case where the memory tags 72y to 72k are to be read immediately after replacing the toner cartridges 70y to 70k. A moving distance U1 of a case where the rotary body 90 is rotated in a fourth direction R4, i.e., counterclockwise direction, from a replacement position of the toner cartridges 70y to 70k to the memory tag reading unit 73 is shorter than a moving distance U2 of a case where the rotary body 90 is rotated in the third direction R3, i.e., clockwise direction. That is, by rotating the rotary body 90 in the fourth direction R4, the time from replacement of the toner cartridges 70y to 70k to the reading of the memory tags 72y to 72k may be shortened.

FIG. 25B is a cross-sectional view illustrating a moving distance of a case where the rotary body 90 is rotated from the replacement position to the developing position. As illustrated in FIG. 25B, a case is considered where a monochrome image is printed using black toner immediately after replacing the toner cartridge 70k. A moving distance of a case where the rotary body 90 is rotated in the fourth direction R4, i.e., counterclockwise direction, from the replacement position of the toner cartridge 70k to the developing position is a moving distance V1. The moving distance V1 is shorter than a moving distance V2 of a case where the rotary body 90 is rotated in the third direction R3, i.e., clockwise direction, from the replacement position of the toner cartridge 70k to the developing position. That is, by rotating the rotary body 90 in the fourth direction R4, the time from replacement of the toner cartridge 70k to the start of monochrome image formation may be shortened. After moving the toner cartridge 70k from the replacement position to the developing position, the image forming apparatus 1 starts the feeding operation of the sheet S and performs image formation to the sheet S.

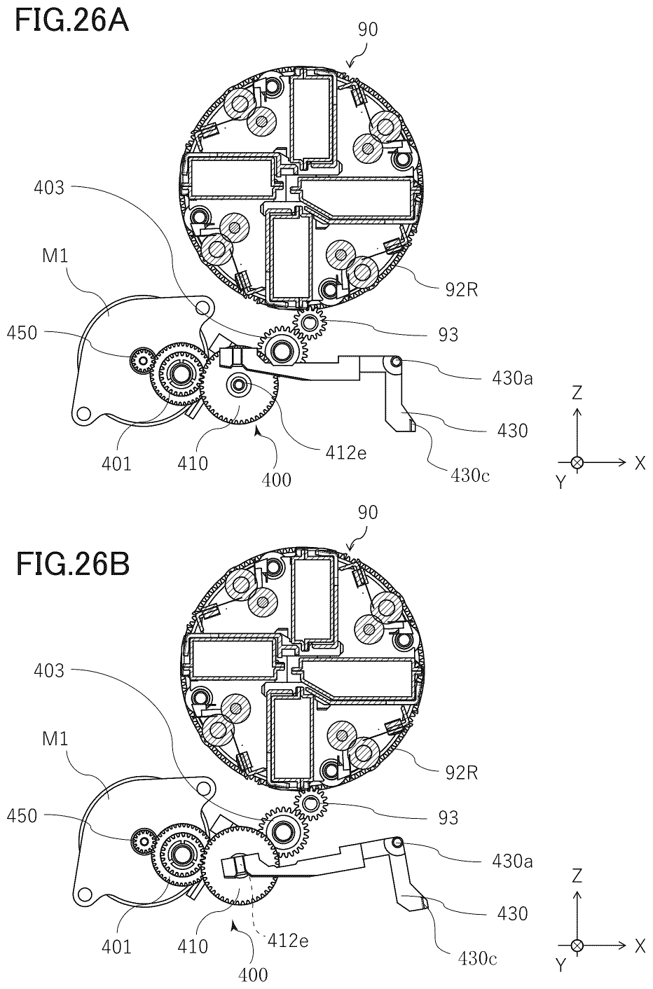

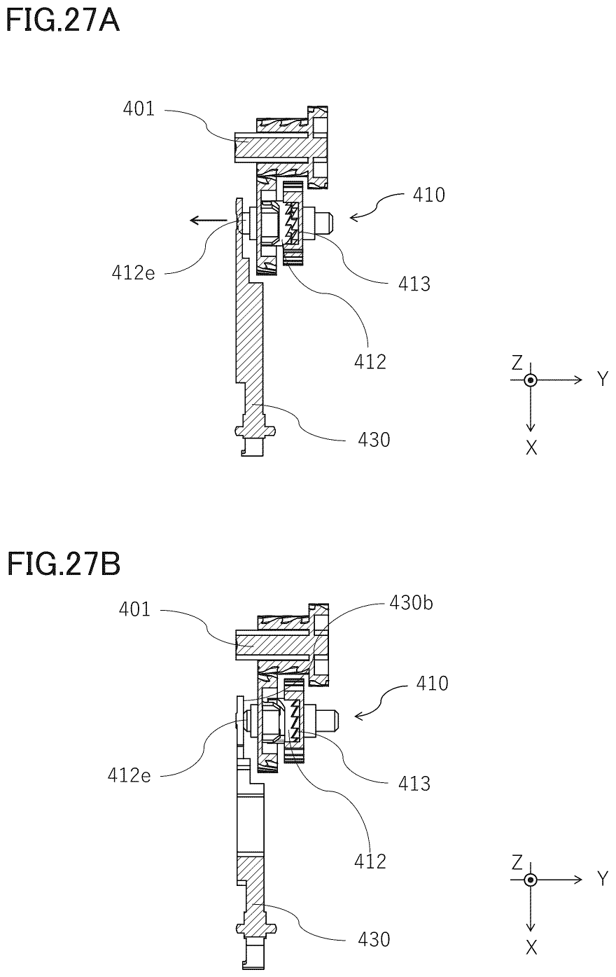

FIGS. 26A and 26B are each a cross-sectional view of the restricting lever 430. FIGS. 27A and 27B are each a cross-sectional view of the operation of the restricting lever 430. As illustrated in FIG. 26A, the restricting lever 430 is disposed on the rotational driving train 400 of the present embodiment. The restricting lever 430 serving as a restriction member is configured pivotably about a pivot shaft 430a that extends in the Y direction, and may move to an allowing position illustrated in FIG. 26A and a restricting position illustrated in FIG. 26B. As illustrated in FIG. 26A, the restricting lever 430 positioned at the allowing position is not overlapped with the shaft 412e of the slide engagement portion 412 when viewed in the Y direction. Meanwhile, as illustrated in FIG. 26B, the restricting lever 430 positioned at the restricting position is overlapped with the shaft 412e of the slide engagement portion 412 when viewed in the Y direction.

More specifically, as illustrated in FIGS. 26A and 27A, the restricting lever 430 allows the slide engagement portion 412 of the rotary driving ratchet gear 410 to be separated from the output portion 413 in the allowing position. In other words, the restricting lever 430 allows the rotary driving ratchet gear 410 to be transitioned to the first transmission state in the allowing position. This is because the restricting lever 430 retracts to the upper direction, i.e., +Z direction, from the shaft 412e in the allowing position. In other words, in the allowing position, the restricting lever 430 does not overlap with a movement locus of a state where the slide engagement portion 412 moves from an engagement position engaged with the output portion 413, i.e., position illustrated in FIG. 20C, to a disengaged position not engaged with the output portion 413, i.e., position illustrated in FIG. 20A.

As illustrated in FIG. 27A, in a state where the restricting lever 430 is positioned at the allowing position and the motor M1 rotates in the second direction R2, the slide engagement portion 412 separates from the output portion 413 and moves to the disengaged position. Therefore, the rotary driving ratchet gear 410 will be in a first non-transmission state.

Meanwhile, as illustrated in FIG. 27B, in a state where the restricting lever 430 is positioned at the restricting position and the motor M1 rotates in the second direction R2, the shaft 412e of the slide engagement portion 412 attempts to separate from the output portion 413 and abuts against the restricting lever 430. Therefore, the movement of the slide engagement portion 412 from the engagement position to the disengaged position is regulated, and the rotary driving ratchet gear 410 maintains the first transmission state. That is, a state where the driving force of the motor M1 is transmitted from the input portion 411 to the output portion 413 is maintained. In this state, the input portion 411 rotates in the CW direction of FIG. 18B, and the rotary body 90 rotates in the fourth direction R4, i.e., counterclockwise direction.

In a state where the motor M1 rotates in the first direction R1, the rotary driving ratchet gear 410 will be in the first transmission state regardless of the position of the restricting lever 430. Therefore, the rotary body 90 rotates in the third direction R3, i.e., clockwise direction.

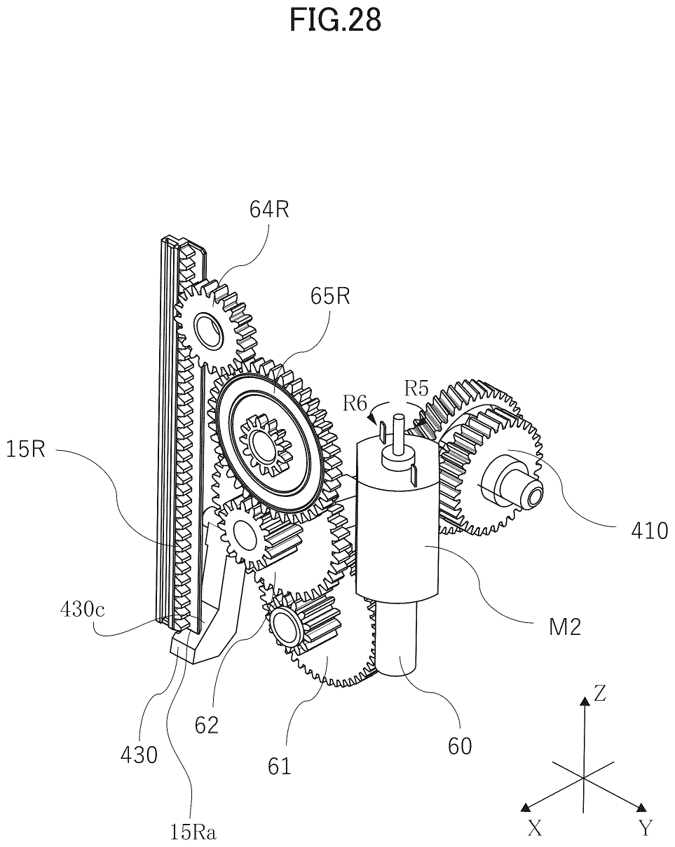

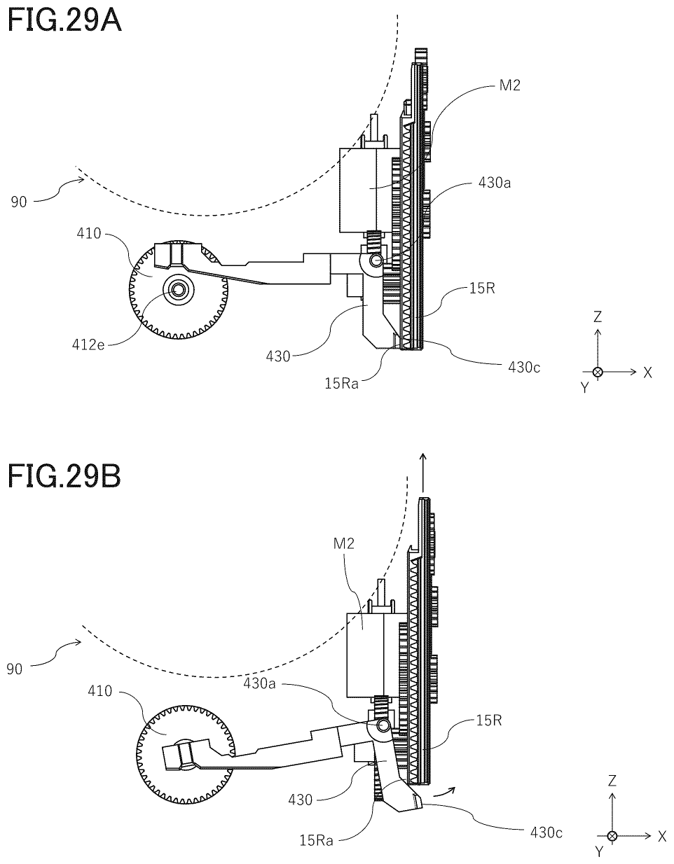

Next, with reference to FIGS. 28 to 29B, a configuration of moving the restricting lever 430 to the allowing position and the restricting position will be described. FIG. 28 is a perspective view of a peripheral configuration of the restricting lever 430. FIGS. 29A and 29B are each a front view illustrating a state where the restricting lever 430 moves to the allowing position and the restricting position. In the present embodiment, the restricting lever 430 is moved using the drive mechanism for moving the tray 80 described with reference to FIGS. 13A and 13B.

As illustrated in FIG. 28, in a state where the motor M2 is rotated in a fifth direction R5, the driving rack 15R serving as a moving member is slid in the upper direction, i.e., +Z direction, via the worm gear 60, the stepped gear 61, the stepped gear 62, the stepped gear 65R, and the drive rack input gear 64R. The driving rack 15R is engaged with a pinion gear 94R and drives the pinion gear 94R serving as a drive receiving member. Then, the tray 80 moves between the accommodation position and the removal position by the pinion gear 94R being driven by the driving rack 15R.

A pressing surface 15Ra capable of pressing a pressed surface 430c of the restricting lever 430 is disposed at a lower end portion of the driving rack 15R. Further, a center of gravity of the restricting lever 430 is determined such that the restricting lever 430 is urged from the allowing position toward the restricting position by its own weight. That is, the center of gravity of the restricting lever 430 is positioned on the −X side from the center of the pivot shaft 430a illustrated in FIG. 29A. By the motor M2 rotating in the fifth direction R5, the tray 80 moves from the accommodation position toward the removal position, and by the motor M2 rotating in a sixth direction R6 opposite to the fifth direction, the tray 80 may move from the removal position toward the accommodation position.

The driving rack 15R is positioned at a first position illustrated in FIG. 29A in a state where the tray 80 is positioned at the accommodation position and before the motor M2 is driven. In this state, the pressing surface 15Ra of the driving rack 15R abuts against the pressed surface 430c of the restricting lever 430, and restricts movement of the restricting lever 430 from the allowing position to the restricting position. In a state where the motor M2 is rotated in the fifth direction R5, the driving rack 15R slides upward, and as illustrated in FIG. 29B, the restricting lever 430 pivots from the allowing position to the restricting position in an interlocked manner with the movement of the driving rack 15R. In FIGS. 29A and 29B, the driving rack 15R is positioned outside the rotational trajectory of the rotary body 90 indicated by the dashed line, such that the driving rack 15R and the rotary body 90 do not interfere with each other.

When the motor M2 is rotated in the sixth direction R6 in a state where the restricting lever 430 is positioned at the restricting position illustrated in FIG. 29B, the driving rack 15R is slid in the downward direction, i.e., −Z direction. Thereby, the pressing surface 15Ra of the driving rack 15R may press the pressed surface 430c of the restricting lever 430 so as to pivot the restricting lever 430 from the restricting position to the allowing position. That is, the motor M2 can be referred to as being able to drive the restricting lever 430 between the allowing position and the restricting position.

Now, timings regarding the switching of the restricting lever 430 from the allowing position to the restricting position, locking of rotation of the rotary body 90, and abutment of the driving rack 15R and a pinion gear 94kR during movement of the tray 80k will be described. The tray 80k will be described below, and the trays 80y to 80c which adopt a similar configuration will not be described. Although the driving rack 15, the locking member 67, and the pinion gear 94k are respectively disposed on both the left and right sides of the apparatus body 1A in the Y direction, for sake of description, the +side in the Y axis direction, i.e., right side, will be described below.

A moving distance of the driving rack 15R when the restricting lever 430 switches from the allowing position to the restricting position is denoted by Z1, a moving distance of the driving rack 15R when locking the rotation of the rotary body 90 is denoted by Z2, and a moving distance of the driving rack 15R when the driving rack 15R and the pinion gear 94kR are abutted is denoted by Z3. The above-mentioned moving distances Z1, Z2, and Z3 are based on a point of time when the driving rack 15R is positioned at the first position. That is, the distances are based on a state where the tray 80 is positioned at the accommodation position and before the motor M2 is driven. The moving distances Z1, Z2, and Z3 satisfy the relationship of Z1<Z2<Z3.

When the motor M2 is rotated in the fifth direction R5 and the driving rack 15R moves to the upper direction, i.e., +Z direction, at a point of time when the driving rack 15R has moved for the moving distance Z1, the restricting lever 430 is switched from the allowing position to the restricting position. As described, a position of the driving rack 15R having moved from the first position for the moving distance Z1 is referred to as a second position. According to the present embodiment, the restricting lever 430 is positioned at the restricting position by being abutted against the driving rack 15R positioned at the second position. In this state, the locking of rotation of the rotary body 90 by the locking member 67 and the abutment of the driving rack 15R and the pinion gear 94kR is not started. That is, the restricting lever 430 moves from the allowing position to the restricting position before the tray 80 starts to move from the accommodation position to the removal position.

At a point of time when the driving rack 15R has moved for the moving distance Z2, if the rotary body 90 is at the replacement posture, as described above, the engagement portion 672 of the locking member 67 is engaged with the engaged portion 99a of the rotary body 90, and the rotation of the rotary body 90 is regulated, i.e., locked. That is, before the tray 80 starts to move from the accommodation position toward the removal position, the locking member 67 moves from a separated position separated from the rotary body 90 to a lock position regulating the rotation of the rotary body 90.

At a point of time when the driving rack 15R has moved for the moving distance Z3, the driving rack 15R, i.e., force applying portion, and the pinion gear, i.e., force receiving portion, 94kR are engaged. In this state, by the motor M2 further rotating in the fifth direction R5 and the driving rack 15R moving upward, the tray 80k may be moved from the accommodation position toward the removal position. Meanwhile, in a state where the motor M2 rotates in the sixth direction R6 and the tray 80k is moved from the removal position to the accommodation position, the restricting lever 430 moves from the restricting position to the allowing position after the driving rack 15R has been separated from the pinion gear 94kR and the locking of the locking member 67 is released.

In order to rotate the rotary body 90 to the fourth direction R4, it is preferable that the motor M2 is stopped in a state where the restricting lever 430 is at the restricting position and the rotation of the rotary body 90 is not regulated, i.e., locked, by the locking member 67. By rotating the motor M1 in the second direction R2 in this state, the rotary body 90 may be rotated in the fourth direction R4.

In the configured illustrated above, the rotational driving train 400 according to the present embodiment may be transitioned to a first state, a second state, and a third state. When the motor M1 rotates in the first direction R1, the rotational driving train 400 is set to the first state, and transmits the drive from the motor M1 to the rotary body 90 such that the rotary body 90 rotates in the third direction R3. When the motor M1 rotates in the first direction R1, the rotary driving ratchet gear 410 will be in the first transmission state regardless of the position of the restricting lever 430. When the rotational driving train 400 is in the first state, the conveyance roller drive train 360 is in the second non-transmission state, and the conveyance roller 321 will not rotate. Therefore, the load on the motor M1 may be reduced.

When the motor M1 is rotated in the second direction R2, the rotational driving train 400 may be transitioned to a second state in which the drive from the motor M1 is not transmitted to the rotary body 90 or to a third state in which the drive from the first motor is transmitted to the rotary such that the rotary body 90 rotates in the fourth direction R4. In this state, if the restricting lever 430 is positioned at the allowing position, the rotational driving train 400 will be in the second state by the rotary driving ratchet gear 410 being in the first non-transmission state. If the rotational driving train 400 is in the second state, the conveyance roller drive train 360 is in the second transmission state. That is, when the motor M1 rotates in the second direction R2, the drive from the motor M1 is transmitted to the conveyance roller 321. As a result, if the sheet S is in contact with the conveyance roller 321, the conveyance roller 321 conveys the sheet S downstream in the conveyance direction. The rotation direction of the conveyance roller 321 in this state may be referred to as a conveyance rotation direction. That is, in a state where the motor M1 rotates in the second direction R2, the conveyance roller drive train 360 transmits the drive from the motor M1 to the conveyance roller 321, and the conveyance roller 321 rotates in the conveyance rotation direction.

Meanwhile, in a state where the restricting lever 430 is positioned at the restricting position, the rotational driving train 400 will be in the third state by the motor M1 rotating in the second direction R2 and the rotary driving ratchet gear 410 being in the first transmission state. In a state where the rotational driving train 400 is in the third state, the conveyance roller drive train 360 is in the second transmission state. In this state, the conveyance roller 321 rotates in the conveyance rotation direction. However, in a state where the rotary body 90 is rotated in the fourth direction R4, the conveyance roller 321 is separated from the sheet S, such that the rotation of the conveyance roller 321 will not influence the conveyance of the sheet S.

As described, by rotating the motor M1 in normal and reverse directions in the first direction R1 and the second direction R2, it may be possible to select whether to rotate the rotary body 90 in the third direction R3 or to rotate the same in the fourth direction R4, according to which the number of motors may be reduced and costs may be cut down. Moreover, the driving rack 15R for moving the tray 80 is used for switching the restricting lever 430 between the allowing position and the restricting position, the number of motors and number of components may be reduced and costs may be cut down.

The rotary body 90 rotates in the third direction R3 when switching colors of the toner image to be formed on the photosensitive drum 2. Meanwhile, as described above, the rotary body 90 is configured rotatable also in the fourth direction R4 opposite to the third direction R3. By having the rotary body 90 rotate in the fourth direction R4, for example, a memory tag 72 attached to the toner cartridge 70 having been replaced may be read speedily. As described, the rotary body 90 rotates in the fourth direction R4 after the toner cartridge 70 has been attached to the developing frame 53 and before the image forming operation to the sheet S is started. Further, by rotating the rotary body 90 in the fourth direction R4, the time from the replacement of the toner cartridge 70k to the starting of monochrome image formation may be shortened.

When the motor M2 is rotated in the sixth direction R6 so as to move the tray 80 from the removal position to the accommodation position, at first, the pinion gear 94R rotates along with the movement of the driving rack 15R and the tray 80 is positioned at the accommodation position. When the motor M2 is rotated further in the sixth direction R6, the driving rack 15R separates from the pinion gear 94R. Then, the locking member 67 separates from the rotary body 90, and the locking of rotation of the rotary body 90 by the locking member 67 is released.

Then, in a state where the locking of rotation of the rotary body 90 by the locking member 67 is released and the restricting lever 430 is at the restricting position, the motor M1 is rotated in the second direction R2, by which the rotary body 90 may be rotated in the fourth direction R4. After rotating the rotary body 90 in the fourth direction R4, when the motor M2 is further rotated in the sixth direction R6, the driving rack 15R is lowered further, and the restricting lever 430 moves from the restricting position to the allowing position.

### Second Embodiment

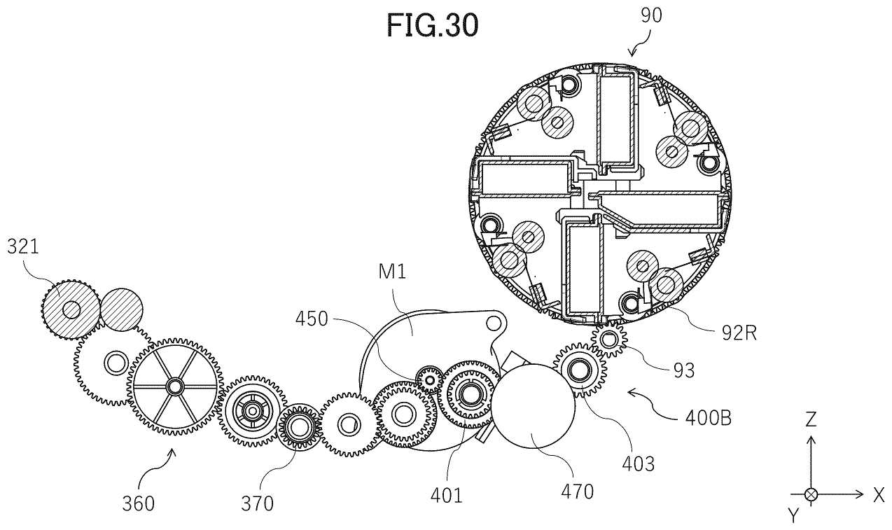

Next, an image forming apparatus according to a second embodiment will be described. The second embodiment adopts an electromagnetic clutch 470 instead of the rotary driving ratchet gear 410 and the restricting lever 430 of the first embodiment. Therefore, configurations similar to the first embodiment are either not shown or denoted with the same reference numbers. FIG. 30 is a view illustrating a rotational driving train 400B serving as a first drive transmission portion according to the second embodiment.

As illustrated in FIG. 30, the driving force output from the motor M1 is transmitted via the pinion gear 450 of the motor M1 to a rotational driving train 400B and the conveyance roller drive train 360. A rotational driving train 400B includes the rotary driving stepped gear 401, the electromagnetic clutch 470, the rotary driving idler gear 403, and the rotary driving gear 93. The rotary body 90 rotates by having drive entered from the rotary driving gear 93 to the disk gear 92R of the rotary body 90.

The electromagnetic clutch 470 may be switched between ON and OFF at an arbitrary timing by the control unit 30, wherein the electromagnetic clutch 470 transmits drive when turned ON and does not transmit drive when turned OFF. That is, the electromagnetic clutch 470 serving as a first electromagnetic clutch may be transitioned between a first transmission state of transmitting the drive from the motor M1 toward the rotary body 90 and a first non-transmission state of not transmitting the drive from the motor M1 toward the rotary body 90.

In the present embodiment, by having the motor M1 rotate in the first direction R1 and having the electromagnetic clutch 470 in the first transmission state, the rotational driving train 400B may be transitioned to a first state in which the drive from the motor M1 is transmitted to the rotary body 90 such that the rotary body 90 rotates in the third direction R3. Further, by having the electromagnetic clutch 470 in the first non-transmission state, the rotational driving train 400B may be transitioned to a second state in which the drive from the motor M1 is not transmitted to the rotary body 90.

Further, by having the motor M1 rotate in the second direction R2 and having the electromagnetic clutch 470 in the first transmission state, the rotational driving train 400B may be transitioned to a third state in which the drive from the motor M1 is transmitted to the rotary body 90 such that the rotary body 90 rotates in the fourth direction R4. Similar to the first embodiment, the rotary body 90 rotates in the fourth direction R4 in a state where the locking of rotation of the rotary body 90 by the locking member 67 is released.

According to the configuration describe above, effects similar to the first embodiment may be exerted, while reducing the number of components and reducing the space occupied by the rotational driving train 400B.

### Third Embodiment

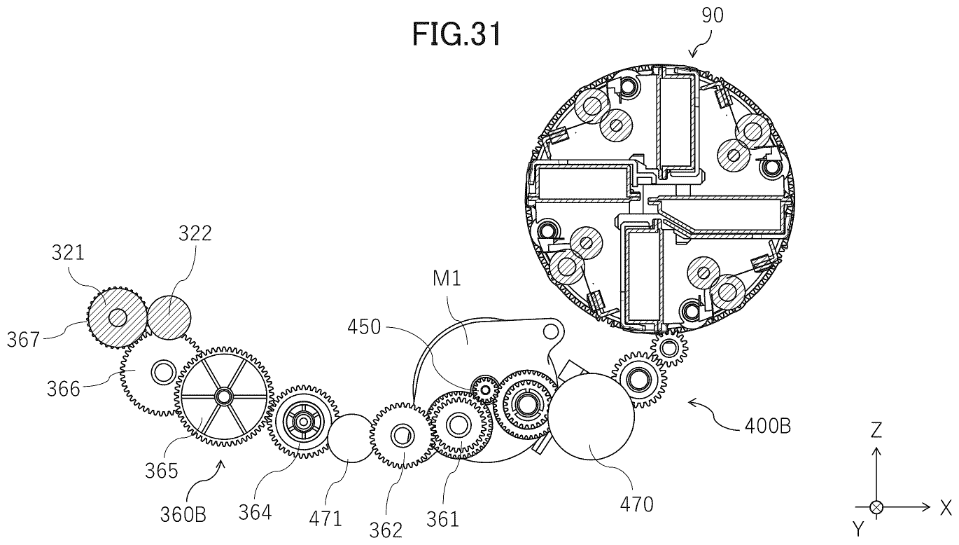

Next, an image forming apparatus according to a third embodiment will be described. The third embodiment adopts an electromagnetic clutch 471 instead of the conveyance driving ratchet gear 370 of the second embodiment. Therefore, configurations similar to the second embodiment are either not shown or denoted with the same reference numbers. FIG. 31 is a view illustrating a conveyance roller drive train 360B according to the third embodiment.

The conveyance roller drive train 360B serving as a second drive transmission portion includes, as illustrated in FIG. 31, the conveyance driving stepped gears 361 and 365, the conveyance driving idler gears 362, 364, and 366, the electromagnetic clutch 471, and the conveyance roller gear 367. By having a drive entered via the conveyance roller gear 367 to the conveyance roller 321, the conveyance roller 321 rotates.

The electromagnetic clutch 471 may be switched between ON and OFF at an arbitrary timing by the control unit 30, wherein the electromagnetic clutch 471 transmits drive when turned ON and does not transmit drive when turned OFF. That is, the electromagnetic clutch 471 serving as a second electromagnetic clutch may be transitioned between a second transmission state of transmitting the drive from the motor M1 toward the conveyance roller 321 and a second non-transmission state of not transmitting the drive from the motor M1 toward the conveyance roller 321.

In the present embodiment, the electromagnetic clutch 471 will be in a second transmission state when the motor M1 rotates in the second direction R2. Thereby, the conveyance roller 321 rotates in the conveyance rotation direction, and in a state where the sheet S is in contact with the conveyance roller 321, the conveyance roller 321 conveys the sheet S downstream in the conveyance direction. Further, the electromagnetic clutch 471 will be in a second non-transmission state when the motor M1 rotates in the first direction R1. Thereby, the conveyance roller 321 will not rotate, and the load on the motor M1 may be reduced. Further, the present embodiment exerts a similar effect as the first embodiment, and at the same time, reduces the number of components and reduces the space occupied by the conveyance roller drive train 360B.

According to the present embodiment, the electromagnetic clutch 470 similar to the second embodiment is also adopted in the rotational driving train 400B, but the present technique is not limited thereto. For example, instead of the rotational driving train 400B, the rotational driving train 400 including the rotary driving ratchet gear 410 and the restricting lever 430 similar to the first embodiment may be adopted.

### OTHER EMBODIMENTS

In any of the embodiments described above, the motor M1 transmits drive to the rotary body 90 and the conveyance roller 321, but the present technique is not limited thereto. For example, the motor M1 may transmit drive to at least one of the pickup roller 310, the feed roller 311, and the sheet discharge roller, instead of the conveyance roller 321. Even in this case, when the rotary body 90 rotates in the fourth direction R4, it is preferable that at least one of the pickup roller 310, the feed roller 311, and the sheet discharge roller is separated from the sheet S. Further, the drive from the motor M1 may be configured to be transmitted not only to the rotary body 90 but also to the first output portion, and even according to this case, it is desirable to realize an image forming apparatus configured to enable the first output portion to be rotated in normal and reverse directions while enabling to cut down costs.

According further to the first embodiment, the rotary driving ratchet gear 410 is switched between the first non-transmission state and the first transmission state by the restricting lever 430 that moves in an interlocked manner with the driving rack 15R when the motor M1 rotates in the second direction R2, but the present technique is not limited thereto. For example, the restricting lever 430 may be switched between the allowing position and the restricting position by a moving member other than the driving rack 15R. Further, instead of the restricting lever 430, the rotary driving ratchet gear 410 may be switched between the first non-transmission state and the first transmission state when the motor M1 rotates in the second direction R2 by an actuator such as a solenoid.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-075518, filed on May 7, 2024 and Japanese Patent Application No. 2025-041798 filed on Mar. 14, 2025, which are hereby incorporated by reference herein in their entirety.

What is claimed is:

1. An image forming apparatus to which a toner cartridge is detachably attached and configured to form an image on a recording material, the image forming apparatus comprising:
a rotary configured to rotate, the rotary including a developing roller, and a storage frame to which the toner cartridge is attachable, the storage frame including a storage portion configured to accommodate toner being supplied to the developing roller,
a conveyance portion configured to convey the recording material;
a first motor configured to drive the rotary and the conveyance portion, the first motor being configured to rotate in a first direction and in a second direction opposite to the first direction;
a first drive transmission portion configured to transmit a driving force from first motor to the rotary; and
a second drive transmission portion configured to transmit a driving force from the first motor to the conveyance portion,
wherein the first drive transmission portion is configured to transition to
(i) a first state of transmitting the driving force from the first motor to the rotary such that the rotary rotates in a third direction in a state where the first motor rotates in the first direction,
(ii) a second state of not transmitting the driving force from the first motor to the rotary in a state where the first motor rotates in the second direction, and
(iii) a third state of transmitting the driving force from the first motor to the rotary such that the rotary rotates in a fourth direction opposite to the third direction in a state where the first motor rotates in the second direction, and
wherein the second drive transmission portion is configured to transmit the driving force from the first motor to the conveyance portion in a state where the first motor rotates in the second direction.

2. The image forming apparatus according to claim 1, wherein the first drive transmission portion includes a first switching portion and a restriction member,
wherein the first switching portion is configured to transition to a first transmission state in which the first switching portion transmits the driving force from the first motor toward the rotary and to a first non-transmission state in which the first switching portion does not transmit the driving force from the first motor toward the rotary,
wherein the restriction member is configured to move to an allowing position in which the restriction member allows the first switching portion to transition to the first non-transmission state and to a restricting position in which the restriction member restricts the first switching portion from transitioning to the first non-transmission state, and
wherein the first switching portion is configured to
(i) transition to the first non-transmission state in a case where the restriction member is positioned at the allowing position and where the first motor rotates in the second direction, in a state where the first drive transmission portion is in the second state, and
(ii) be regulated from transitioning to the first non-transmission state in a case where the restriction member is positioned at the restricting position and where the first motor rotates in the second direction, in a state where the first drive transmission portion is in the third state.

3. The image forming apparatus according to claim 2, wherein the first switching portion includes a first rotation member, and a second rotation member configured to move to an engagement position being engaged with the first rotation member so as to rotate integrally with the first rotation member and to a disengaged position so as not to rotate integrally with the first rotation member, the first switching portion being in the first transmission state in a state where the second rotation member is positioned at the engagement position, the first switching portion being in the first non-transmission state in a state where the second rotation member is positioned at the disengaged position, and
wherein the restriction member is configured not to overlap with a movement locus of the second rotation member moving from the engagement position to the disengaged position at the allowing position, and configured to overlap with the movement locus at the restricting position.

4. The image forming apparatus according to claim 2, further comprising a second motor configured to move the restriction member between the allowing position and the restricting position.

5. The image forming apparatus according to claim 4, further comprising a moving member configured to be moved by the second motor,
wherein the rotary includes a drive receiving member configured to be driven by the moving member, and
wherein the restriction member is at the allowing position in a case where the moving member is at a first position, and is at the restricting position in a case where the moving member is at a second position that differs from the first position.

6. The image forming apparatus according to claim 5, further comprising:
a main frame configured to accommodate the rotary and provided with an opening; and
a support member configured to support the toner cartridge attachably and detachably, the support member being configured to move through the opening from an accommodation position to a removal position, the accommodation position being a position in which the support member is accommodated in the storage frame, the removal position being a position in which at least a portion of the support member is exposed outside the main frame and in which the toner cartridge is removable from the support member,
wherein the support member is configured to move between the accommodation position and the removal position by having the drive receiving member driven by the moving member.

7. The image forming apparatus according to claim 5, wherein the restriction member is urged from the allowing position toward the restricting position, is positioned at the allowing position by abutting against the moving member positioned at the first position, and is positioned at the restricting position by abutting against the moving member positioned at the second position.

8. The image forming apparatus according to claim 7, wherein the restriction member is urged by an own weight of the restriction member from the allowing position toward the restricting position.

9. The image forming apparatus according to claim 5, wherein the restriction member is configured to pivot between the allowing position and the restricting position, and
wherein the moving member is configured to slide between the first position and the second position.

10. The image forming apparatus according to claim 6, wherein the second motor rotates in a fifth direction in a case where the support member is moved from the accommodation position to the removal position, and
wherein the restriction member moves from the allowing position to the restricting position in a case where the second motor rotates in the fifth direction and before the support member starts to move from the accommodation position toward the removal position.

11. The image forming apparatus according to claim 6, further comprising a locking member configured to move to a separated position being separated from the rotary and to a lock position being engaged with the rotary so as to regulate a rotation of the rotary,
wherein the locking member moves from the separated position to the lock position by a driving force from the second motor.

12. The image forming apparatus according to claim 11, wherein the second motor rotates in a fifth direction in a case where the support member is moved from the accommodation position to the removal position, and
wherein the locking member moves from the separated position to the lock position in a case where the second motor rotates in the fifth direction and before the support member starts to move from the accommodation position toward the removal position.

13. The image forming apparatus according to claim 1, wherein the first drive transmission portion includes a first electromagnetic clutch configured to transition to a first transmission state of transmitting the driving force from the first motor toward the rotary and to a first non-transmission state of not transmitting the driving force from the first motor toward the rotary, and
wherein the first electromagnetic clutch is in the first transmission state in a case where the first drive transmission portion is in the first state or the third state, and is in the first non-transmission state in a case where the first drive transmission portion is in the second state.

14. The image forming apparatus according to claim 1, wherein the second drive transmission portion includes a second switching portion configured to transition to a second transmission state of transmitting the driving force from the first motor toward the conveyance portion and to a second non-transmission state of not transmitting the driving force from the first motor toward the conveyance portion,
wherein the second switching portion is in the second non-transmission state in a case where the first motor rotates in the first direction, and
wherein the second switching portion is in the second transmission state in a case where the first motor rotates in the second direction.

15. The image forming apparatus according to claim 1, wherein the second drive transmission portion includes a second electromagnetic clutch configured to transition to a second transmission state of transmitting the driving force from the first motor toward the conveyance portion and to a second non-transmission state of not transmitting the driving force from the first motor toward the conveyance portion, and
wherein the second electromagnetic clutch is in the second transmission state in a case where the first motor rotates in the second direction.

16. The image forming apparatus according to claim 1, further comprising a photosensitive drum on which an electrostatic latent image is developed as a toner image by the developing roller,
wherein the rotary is configured to rotate in the third direction in a case where a color of the toner image to be formed on the photosensitive drum is switched.

17. The image forming apparatus according to claim 1, wherein the rotary is configured to rotate in the fourth direction after the toner cartridge has been attached to the storage frame and before an image forming operation to the recording material is started.

18. An image forming apparatus that forms an image on a recording material, the image forming apparatus comprising:
a first output portion;
a second output portion that differs from the first output portion;
a first motor configured to drive the first output portion and the second output portion, the first motor being configured to rotate in a first direction and in a second direction opposite to the first direction;
a first drive transmission portion including a switching portion and a restriction member, the first drive transmission portion being configured to transmit a driving force from the first motor to the first output portion;
a second drive transmission portion configured to transmit a driving force from the first motor to the second output portion; and
a second motor configured to drive the restriction member,
wherein the switching portion is configured to transition to a transmission state in which the switching portion transmits the driving force from the first motor toward the first output portion and to a non-transmission state in which the switching portion does not transmit the driving force from the first motor toward the first output portion,
wherein the restriction member is configured to move by the driving force from the second motor to an allowing position in which the restriction member allows the switching portion to transition to the non-transmission state and to a restricting position in which the restriction member restricts the switching portion from transitioning to the non-transmission state,
wherein the first drive transmission portion is configured to transition to a first state, a second state, and a third state, the first drive transmission portion, in the first state, transmitting the driving force from the first motor to the first output portion such that the first output portion rotates in a third direction in a case where the first motor rotates in the first direction, the switching portion, in a state where the first drive transmission portion is in the second state, transitioning to the non-transmission state in a case where the restriction member is positioned at the allowing position and where the first motor rotates in the second direction, the first drive transmission portion, in the third state, transmitting the driving force from the first motor to the first output portion such that the first output portion rotates in a fourth direction opposite to the third direction in a case where the restriction member is positioned at the restricting position and where the first motor rotates in the second direction, and
wherein the second drive transmission portion transmits the driving force from the first motor to the second output portion in a state where the first motor rotates in the second direction.

19. The image forming apparatus according to claim 18, further comprising:
a rotary configured to rotate and including:
a developing roller; and
a storage frame including a storage portion configured to accommodate toner being supplied to the developing roller, the storage frame being configured to have a toner cartridge attached thereto.

20. The image forming apparatus according to claim 19, further comprising a locking member configured to move to a separated position being separated from the rotary and to a lock position being engaged with the rotary so as to regulate a rotation of the rotary,
wherein the locking member moves from the separated position to the lock position by the driving force from the second motor.
